(19) United States
(12) Patent Application Publication
(10) Pub. No.: US 2025/0280040 A1
(43) Pub. Date: Sep. 4, 2025

(54) NR SECURITY ENHANCEMENTS

(71) Applicant: InterDigital Patent Holdings, Inc., Wilmington, DE (US)

(72) Inventors: Kai-Erik Sunell, Naantali (FI); Pascal Adjakple, Great Neck, NY (US); Jerome Vogedes, Milwaukee, WI (US); Kyle Pan, Saint James, NY (US)

(73) Assignee: InterDigital Patent Holdings, Inc., Wilmington, DE (US)

(21) Appl. No.: 18/702,566

(22) PCT Filed: Nov. 4, 2022
(86) PCT No.: PCT/US2022/079273

§ 371 Date: Apr. 18, 2024

Related U.S. Application Data
(60) Provisional application No. 63/275,995, filed on Nov. 5, 2021.

(51) Int. Cl. H04L 9/40

(52) U.S. Cl. CPC H04L 63/20

(57) ABSTRACT

Radio security enhancements may include methods for derivation and selection of input parameters for security functions in radio protocol stack. Systems may relocate security protection functions to lower layers of the radio protocol stack.

### CROSS-REFERENCE TO RELATED APPLICATIONS

This application claims the benefit of U.S. Provisional Patent Application No. 63/275,995, filed on Nov. 5, 2021, entitled “NR Security Enhancements,” the contents of which are hereby incorporated by reference herein.

### BACKGROUND

The Radio Resource Control (RRC) protocol is used in UMTS, LTE and 5G on the Air interface. It is a layer 3 (Network Layer) protocol used between UE and Base Station. This protocol is specified by 3GPP in TS 25.331 for UMTS, in TS 36.331 for LTE and in TS 38.331 for 5G New Radio. RRC messages are transported via the PDCP-Protocol. Many radio interface functions are placed to layer 3 because layer 3 is protected, but that does not mean that they otherwise fit in layer 3.

This background information may be provided to reveal information believed by the applicant to be of possible relevance. No admission is necessarily intended, nor should be construed, that any of the preceding information constitutes prior art.

### SUMMARY

Disclosed herein are methods, systems, and devices that may assist in new radio (NR) security enhancements. Methods, systems, or devices may help derive and select input parameters for security function in radio protocol stack. Methods, systems, or devices may address system performance by relocating security protection functions to lower layers of the radio protocol stack. Methods, systems, or devices may address overhead problems caused by authentication codes in broadcasted system information.

In an example, an apparatus may include a processor and a memory coupled with the processor that effectuates operations. The operations may include determining a radio protocol data type of a plurality of radio protocol data types of information transmitted in a communication: based on the radio protocol data type, selecting, for performing a security function on the information, one or more input parameters specific to the radio protocol data type; and performing the security function on the information using the one or more input parameters specific to the radio protocol data type. The plurality of radio protocol data types may include control protocol data unit (PDU), header of control PDU, header of data PDU, or radio resource control (RRC) message using common control channel (CCCH), among other things. The security function may include a ciphering protection function or an integrity protection function.

This Summary may be provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates a security architecture;

FIG. 2 illustrates a key derivation:

FIG. 3 illustrates a control plane architecture:

FIG. 4 illustrates a user plane architecture:

FIG. 5 illustrates a ciphering of data:

FIG. 6 illustrates a derivation of MAC-I/NAS-MAC (or XMAC-I/XNAS-MAC);

FIG. 7 illustrates a PDCP Control PDU format:

FIG. 8 illustrates a RLC Status PDU format:

FIG. 9 illustrates an example of DL MAC PDU with MAC CEs;

FIG. 10 illustrates an exemplary flow for configuration, subsequent deactivation, or activation;

FIG. 11 illustrates an exemplary method for performing security protection functions:

FIG. 12 illustrates an exemplary display (e.g., graphical user interface) that may be generated based on the methods, systems, and devices of NR security enhancements:

FIG. 13A illustrates an example communications system:

FIG. 13B illustrates an exemplary system that includes RANs and core networks:

FIG. 13C illustrates an exemplary system that includes RANs and core networks:

FIG. 13D illustrates an exemplary system that includes RANs and core networks:

FIG. 13E illustrates another example communications system:

FIG. 13F is a block diagram of an example apparatus or device, such as a WTRU; and

FIG. 13G is a block diagram of an exemplary computing system.

### DETAILED DESCRIPTION

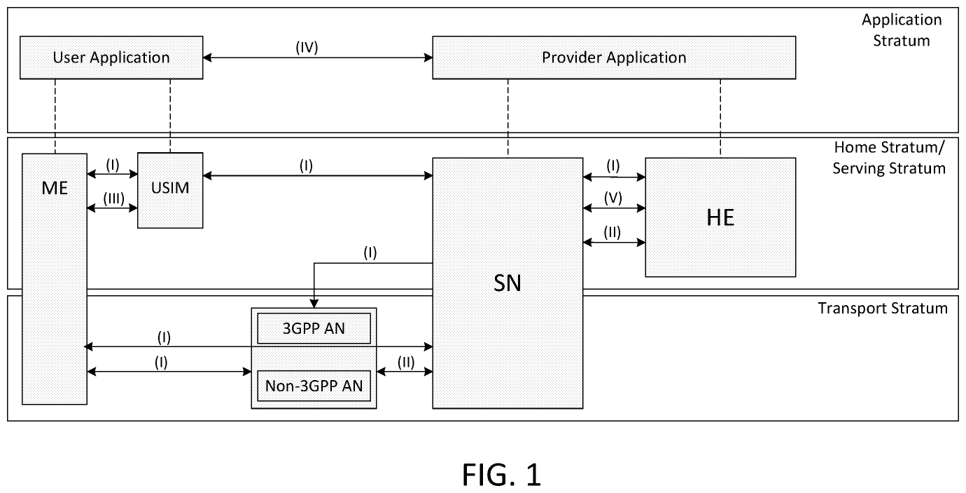

3GPP TS33.501 specifies security architecture and key derivation methods for 5G security. The security architecture is composed of application stratum, home stratum and transport stratum. Network access security, marked as (I) in FIG. 1 below, provides the set of security features that enable a User Equipment (UE), defined as Mobile Entity (ME) and Universal Subscriber Identity Module (USIM), to authenticate and access services via the network securely. In addition, it includes the security context delivery from Serving Network (SN) to Access Network (AN) for the access security.

The key derivation is based on the concept of anchor key KSEAF which may be derived by the Security Anchor Function (SEAF) from an intermediate key called the KAUSF provided by Authentication Server Function (AUSF). The KAUSF is established between the User Equipment (UE) and Home Network (HN) resulting from the primary authentication procedure known as Authentication and Key Agreement (AKA) procedure. The credentials for primary authentication reside in the USIM and HN.

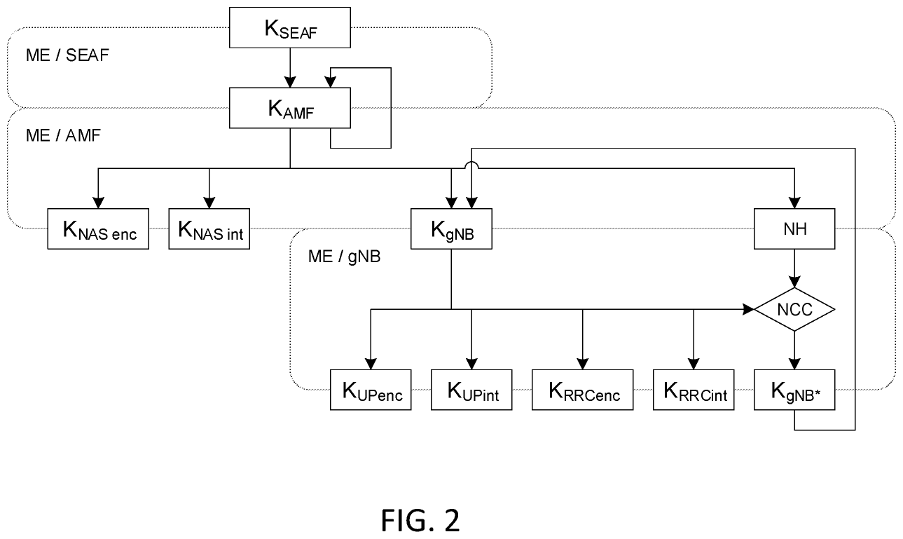

Keys for Access Stratum (AS) and Non-Access Stratum (NAS) security contexts are derived from the anchor key as shown in FIG. 2. See 3GPP TS 38.300. K_{AMF} key may be derived from KSEAF for Access and Mobility Function (AMF) and ME. K_{AMF} may be used for the derivation of NAS protocol encryption key K_{NASenc} or integrity protection key K_{NASint}.

A separate key K_{gNB} is further derived from K_{AMF} for AS security where encryption or integrity protection keys are needed. User plane encryption key K_{UPenc} or integrity protection key K_{UPint} are derived from K_{gNB}. Control plane encryption key K_{RRCenc} and K_{RRCint} are further derived in the same manner. Note that AS keys K_{RRCenc} and K_{RRCint} are aimed to be used for the radio interface control plane signaling even though they are named according to Radio Resource Control (RRC) protocol (from historical reasons).

In addition, a separate parameter for Next Hop (NH) may be derived from K_{AMF} and associated with a Next Hop Chaining Counter (NCC). In addition, every K_{gNB} is associated with the NCC corresponding to the NH value from which it was derived. If the UE 102 is handed over from one gNB 140 to another, target gNB key, called K_{gNB*} may be derived from either the currently active K_{gNB} or from the NH parameter.

If K_{gNB*} may be derived from the currently active K_{gNB}, the key derivation is referred to as a horizontal key derivation. It is indicated to the UE 102 with an NCC that does not increase. If the KgNB* may be derived from the NH parameter, the derivation is referred to as a vertical key derivation. It is indicated to UE 102 with an NCC increase. K_{RRCint}, K_{RRCenc}, K_{UPint} and K_{UPenc} are derived based on K_{gNB} after a new K_{gNB} may be derived.

AS security functions are placed in the packet data convergence protocol (PDCP) layer of the radio protocol stack. See 3GPP TS 38.323. Ciphering provides user data confidentiality or integrity protection provides user data integrity for Data Radio Bearers (DRB). Likewise, ciphering provides signaling data confidentiality for Signaling Radio Bearers (SRB). It should be noted that hereinafter, the terms ciphering or confidentiality may be used interchangeably.

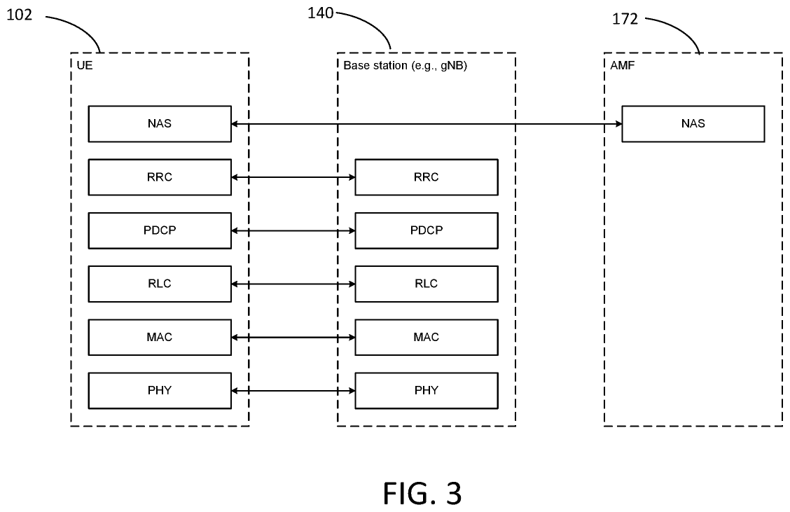

SRBs are provided to RRC layers which is above PDCP. See 3GPP TS 38.331. The Control Plane (CP) architecture is shown in FIG. 3.

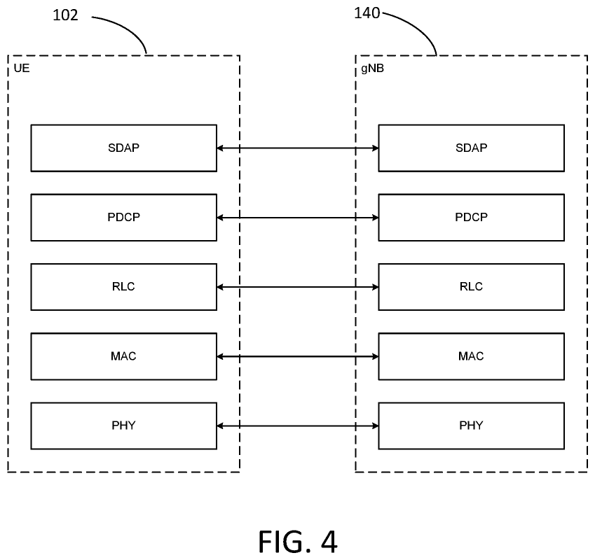

DRBs are provided to Service Data Adaptation Protocol (SDAP) layer which is above PDCP. See 3GPP TS 37.324. The User Plane (UP) architecture is shown in FIG. 4.

Conventionally, ciphering or integrity protection are optional for UP. Conventionally, for CP ciphering is optional but integrity protection may be configured. It means that RRC signaling is at least integrity protected as soon as the security context setup is completed.

AS security context is set up by the core network after successful RRC connection request. Consequently, some signaling is needed over the radio interface prior to security context setup. 3GPP radio protocol stacks distinguish between different Signaling Radio Bearers (SRBs) whether they secure or not. NRs SRBs are conventionally defined as follows. SRB0 may be used for common control channels prior to security context setup and therefore it is neither integrity protected nor it can use confidentiality protection. SRB1 may be used for dedicated signaling after security context setup and it is integrity protected or confidentiality protected. SRB2 may be used for transfer of NAS signaling over radio interface CP after security context setup and, similar to SRB1, it is integrity protected or confidentiality protected. SRB2 is configured after SRB1. If SRB2 is not yet configured, SRB1 may be used for NAS signaling. SRB3 may be used for dedicated signaling in EUTRA NR dual connectivity deployments.

It should be noted that even though both SRB1 and SRB2 may be used for NAS signaling, the rationale for defining two SRBs that can serve same purpose is that they may be configured with different priorities.

5G security algorithms and their input parameters may be reused solutions from 4G and 3G. Even though the algorithms have remained essentially the same in 3GPP Releases, the derivation of input parameters are evolved due to new services, use-cases, or logical nodes. For example, there are differences in parameter derivations in UE 102 and network communication as compared to sidelink (e.g., UE-to-UE), and between AS and NAS.

Security is one significant part of communication. However, the basic principles in AS security have not changed much. Conventional security protects only L3 (e.g., dedicated RRC messages and user plane data) in RRC connected mode, leaving the other parts including L1/L2 control and header unprotected. Examples of messages that are unprotected may include: L3 RRC SI, paging messages and DCI for SI/paging in RRC Idle/Inactive, RRC messages on CCCH, MAC header, DCI for the initial access during transition to RRC connected, MAC CEs, Control PDU, PDCP/RLC/MAC, DCI, and PUCCH in RRC connected. See Table 1. The disclosed subject matter may address issues of the derivation of the inputs other than the security keys, to be used in the ciphering algorithm or integrity protection algorithm, for the security protection of the message described herein.

TABLE 1

| | IDLE/INACTIVE | TRANSITION | CONNECTED |
|---|---|---|---|
| L3 RRC | System Information, | CCCH | DCCH |
| | Paging | | |
| L3 UP data | N/A | N/A | DTCH |
| L2 control | N/A | MAC CE | MAC CEs, Control |
| | | | PDU |
| L2 header | N/A | MAC | PDCP/RLC/MAC |
| L1 PHY | DCI for SI, | DCI for the | DCI, PUCCH |
| | Paging | initial Access | |

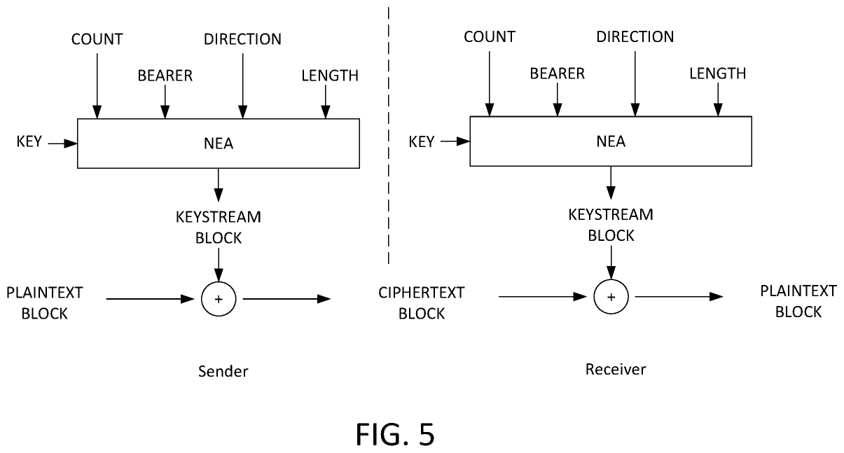

The parameters of the ciphering algorithm are shown in FIG. 5 and explained below. The input parameters of the ciphering algorithm are bearer, key, count, direction, or length. Bearer is a 5 bits field. It is defined as the bearer Identity (ID) configured by RRC. Upon absence of such an ID, 5 Least Significant Bits (LSB) of Logical Channel Identity (LCID) has been used for sidelink. See GPP TS 33.303. LCIDs are configured by RRC. Logical channels and their mapping to transport channels are defined in medium access control (MAC) protocol.

Key is the encryption key K_{NASenc}, K_{UPenc}, or K_{RRCenc}. Conventionally, NAS has only one encryption key because it provides only signaling whereas AS has two keys to distinguish between UP and CP.

Count may be a 32-bit field to provide protection against replay attacks. AS provides a value from PDCP layer where COUNT may be defined as a concatenation of PDCP sequence number and Hyper Frame Number (HFN). PDCP may be responsible to maintain HFN synchronized between the gNB 140 and UE 102 but HFN value itself may never be transferred over the radio interface. HFN is reset to 0) upon handovers and during PDCP (re-)establishments. Similarly, NAS layer provides a NAS COUNT value from NAS sequence number. The derivation of COUNT in 4G is very similar to 5G solutions but COUNT has also been used in 3G for voice traffic solely with an HFN without concatenation to a protocol layer sequence number. See 3GPP TS 25.321.

Direction refers to uplink or downlink where 0 means uplink and 1 means downlink. For sidelink, direction is set to 1 for direct link signaling transmitted by the UE 102 that sent the Direct Security Mode Command message for the security context and 0 otherwise. See 3GPP TS 33.303. Length is the length of the plaintext block to be ciphered.

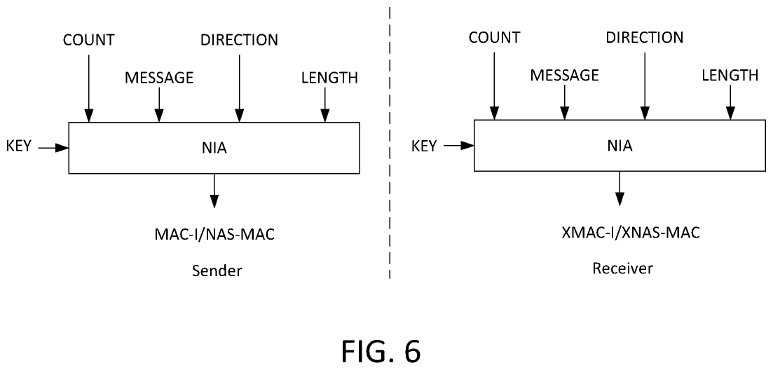

The parameters of the integrity algorithm are shown in FIG. 6 and explained below. The parameters are similar to those of the ciphering algorithm. However, the purpose of the algorithm is only to derive an authentication code as a function of the input parameters and the message content. Therefore, the message bitstring itself is an input to the algorithm and there is no need to indicate the length. Otherwise, COUNT, DIRECTION, and BEARER are derived in the same manner as for the ciphering algorithm. The parameters of integrity protection algorithm are as follows: bearer, key, count, direction, or message.

Bearer is a 5 bits field. It is defined as the bearer Identity (ID) configured by RRC. Upon absence of such an ID, 5 Least Significant Bits (LSB) of Logical Channel Identity (LCID) has been used for sidelink. See 3GPP TS 33.303. LCIDs are configured by RRC. Logical channels and their mapping to transport channels are defined in Medium Access Control (MAC) protocol. In 4G NAS, the parameter has also been permanently set to a constant value 0x00 without any security issues.

Key is the integrity protection key K_{NASint}, K_{UPint}, Or K_{RRCint}. NAS has only one integrity protection key because it provides only signaling whereas AS has two keys to distinguish between UP and CP.

Count may be a 32-bit field to provide protection against replay attacks also for the integrity protection algorithm. Similar to ciphering, AS provides a value from PDCP layer where COUNT may be defined as a concatenation of PDCP sequence number and HFN. PDCP is again responsible to maintain HFN synchronized between the gNB 140 (e.g., base station 140) and UE 102 but HFN value itself may never be transferred over the radio interface. HFN is reset to 0 upon handovers and during PDCP (re-)establishments. Similarly, NAS layer provides a NAS COUNT value from NAS sequence number as an outcome of concatenation with an OVERFLOW counter which is maintained synchronized between the AMF 172 and UE 102. The derivation of COUNT in 4G is very similar to 5G solutions.

Direction refers to uplink or downlink where 0 means uplink and 1 means downlink. For sidelink, DIRECTION is set to 1 for direct link signaling transmitted by the UE 102 that sent the Direct Security Mode Command message for the security context and 0 otherwise. See 3GPP TS 33.303. Message is the plaintext block whereof authentication codes are computed.

The output of the computation is a Message Authentication Code for Integrity (MAC-I) or NAS/MAC. The authentication code is denoted as XMAC-I and XNAS-MAC at the receiver side.

Security issues have been identified with unprotected lower layers (below PDCPC). The security concerns are related to false base stations dropping, altering, or injecting unprotected messages, such as associated with pre-authentication traffic or PDCP/RLC/MAC layer control, as further described herein.

Pre-authentication traffic where a false base station may perform a Denial of Service (DOS) attack by issuing RRC Rejection messages to connection requests. This is possible because both connection request and the corresponding response messages are exchanged prior to security context setup.

PDCP/RLC/MAC layer control messages may be tampered in a man-in-the-middle attacked, dropped, or altered and false messages may be injected because L2 control PDUs (including PDCP control PDUs), status PDUs, Buffer Status Reports (BSRs), or Control Elements (CEs) are not protected.

Security issues with system information (SI) broadcast and system information blocks (SIBs) have also been identified. A false base station may broadcast SI and SIBs and thereby e.g., make UEs camp on the false base station. There are generally multiple different approaches to address the aforementioned issues.

In an example approach, SI and SIBs may be appended with a digital signature based on public key encryption. Unlike symmetric key encryption where the same key may be used for both encryption and decryption, public key techniques are based on two keys where encryption may be done with one key and decryption with another. These two keys are referred to as public and private key. It means that the base station 140 can prepare a digital signature with its private key whereas the public key is available to the UEs. The UEs can verify if the SI and SIBs are from a legitimate source by using the public key.

In another example, the approach may be to compute a hash value from SI and SIBs and pass that information to the network side. The network can compute the same hash values and verify if the reported values from the UE 102 are consistent with those at the network side. In that way, it is possible to at least detect if the UE 102 has read SI or SIBs from a false base station.

There are multiple issues that the disclosed subject matter may address, such as L1/L2 air interface security, moving signaling with efficient performance, or system information overhead.

Issue 1: Where L1/L2 air interface security should be placed and what are the corresponding input parameters for L1/L2 security algorithms?

To secure the L2 air interface protocol messages, for example the control PDU generated by these protocols, or to secure the L1 air interface protocol messages, for example the DCI messages, the placement of the security functions should be specified. Furthermore, the existing security protection algorithms (e.g., cyphering or integrity) used for the protection of L3 messages, such as RRC messages or NAS messages, or for the protection of user data from layers above L3, may require a number of input parameters as disclosed with reference to FIG. 5 or FIG. 6. These input parameters may be specified in support of the security protection of L2 or L1 air interface messages. There are several possibilities for the placement of security functions in L1/L2 (i.e., L1 or L2), which impacts the selection of security parameters. Conventionally, 5G (and 4G) security functions are placed in the PDCP layer. Therefore, an issue that may be addressed may be the derivation of the input parameters to security algorithms, assuming security functions, e.g., ciphering protection functions or integrity protection functions may be exclusively performed by a given protocol layer in L1/L2, or assuming the security functions are distributed across the L1/L2 protocols. Furthermore, there may be a need to specify capability approaches (e.g., options) and related signaling between the UE 102 and the network.

BEARER parameter—PDCP. Conventionally, PDCP layer has one entity per bearer and the entity makes use of bearer IDs to provide BEARER parameter input to integrity and confidentiality protection algorithms for both SRBs and DRBs. SRB1, SRB2, and SRB3 bearer IDs are used as input parameters for RRC generated data, and DRB IDs are used for UP data. However, PDCP control PDUs are not integrity and not confidentiality protected, and they are not configured with any bearer information. If PDCP control PDUs are to be protected, conventionally it is unclear what kind of value should be used for BEARER input parameter.

BEARER parameter—RLC. The data from PDCP may be mapped to RLC entities. See 3GPP TS 38.322. Similar to PDCP control PDUs, RLC status PDUs are not configured with any bearer information. Unlike PDCP control PDUs which are used for DRBs only, RLC status PDUs are used for both SRBs and DRBs. If RLC status PDUs are to be protected, conventionally it is unclear what kind of value should be used for BEARER input parameter.

In addition, there may be up to eight RLC entities per PDCP entity. RLC entities have bearer IDs and associated logical channels as configured by RRC, but security protection by using bearer IDs as the BEARER parameter may result into redundancy because multiple RLC entities may use the same bearer ID. Conventionally, it is unclear how to assign different values for the input parameter BEARER such that redundancy may be avoided between RLC entities.

In principle, LCIDs may be used as a BEARER input parameter (in the same manner as for sidelink), but multiple RLC entities may be associated with the same LCID which also results into undesirable redundancy.

BEARER parameter—MAC. The MAC layer provides logical channels towards RLC layer and further maps logical channels to transport channels. See 3GPP TS 38.321. Conventionally, it is difficult to see how to use bearer IDs as a BEARER input parameter because there may be no notion of bearers on MAC layer.

LCIDs may be not an obvious replacement of bearer IDs because data from multiple logical channels may be mapped onto the same MAC PDU. If a transport block includes data from multiple logical channels, conventionally it is unclear which one of the LCIDs should be used as an input for security algorithm(s). Note that there are no transport channel IDs which may be used instead of LCIDs.

BEARER parameter—PHY. Similar to L2 sublayers RLC and MAC, there are no bearer IDs on PHY. In addition, LCIDs may be hidden to L1.

COUNT parameter-PDCP. Currently, PDCP maintains a COUNT parameter which may be associated with a bearer and composed of a concatenation of PDCP sequence number with HFN. The HFN may be maintained synchronized between the UE 102 and network based on events, such as handovers or PDCP re-establishments. The network may be responsible to ensure that the COUNT value does not wrap around. However, PDCP control PDU format does not contain any sequence number field and therefore conventionally it is unclear how the COUNT may be obtained for PDCP control PDUs.

COUNT parameter-RLC. RLC layer has a sequence number field, but the field length may not be fixed. Unacknowledged Mode (UM) PDU may use 6 or 12 bits sequence numbers whereas AM RLC may use 12 or 18 bits sequence numbers. RLC sequence numbers—especially the UM RLC 6 bit sequence number—are short compared to PDCP's 32 bit COUNT value. An open question is how to make use of RLC layer sequence number to generate a COUNT value that may provide as good protection against replay attacks as PDCP COUNT.

COUNT parameter-MAC. MAC PDU formats do not have any sequence number fields. It is not obvious where to obtain COUNT.

COUNT parameter-PHY. PHY data units do not have sequence number fields. It is not obvious where to obtain COUNT.

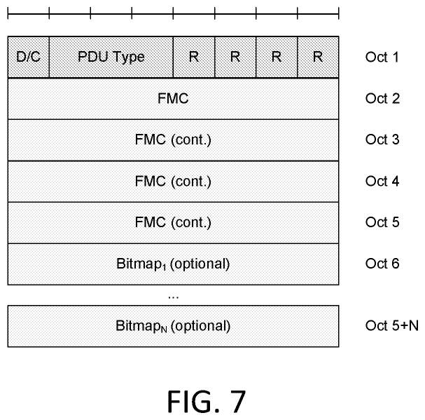

MESSAGE parameter-PDCP. The MESSAGE parameter may be an input parameter of the integrity protection algorithm. It may be defined as the bitstring whereof authentication code may be derived. The conventional PDCP Control PDUs do not have fields or formats to convey authentication codes, as shown in FIG. 7. FIG. 7 illustrates an example PDCP Control PDU format.

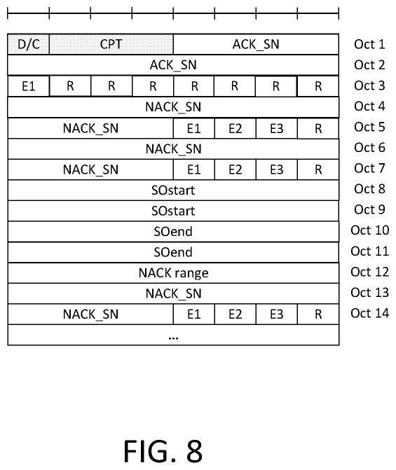

MESSAGE parameter-RLC. The conventional RLC Status PDUs do not have fields or formats to convey authentication codes, as shown in FIG. 8. FIG. 8 illustrates an example RLC Status PDU format.

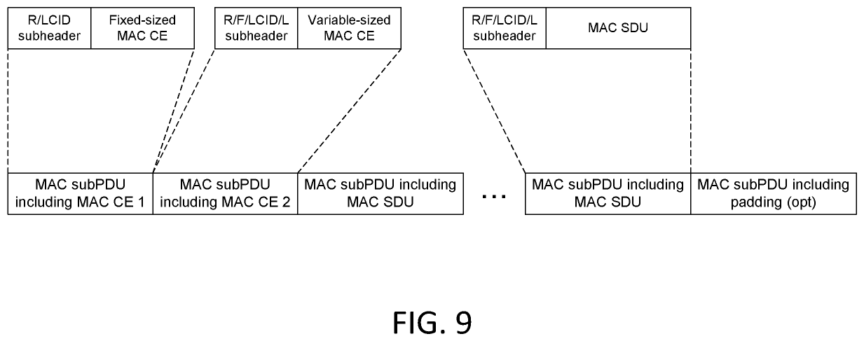

MESSAGE parameter-MAC. Unlike PDCP and RLC PDUs, MAC PDUs are composed of multiple sub-PDUs and their sub-headers, as shown in FIG. 9. Each sub-header is followed by padding, MAC Service Data Unit (SDU), or MAC Control Element (CE), but there are no formats or fields to convey authentication codes for MAC CEs. FIG. 9 illustrates an example of DL MAC PDU with MAC CEs.

MESSAGE parameter-PHY. There are no formats, fields, or reserved resources to convey authentication codes for PHY control data.

Issue 2: How to improve system performance by moving signaling from L3 to secure L2/L1?

Many radio interface functions are placed to L3 because L3 may be protected but that does not mean that they otherwise would fit to L3. In many case, L2/L1 may be a better choice because lower layers have faster responsiveness and lower overhead impact. For example, fast activation of features contributes to latency or efficiency improvements, and fast deactivation may help energy consumption problems, but currently this is not possible because activation and deactivation mechanisms are embedded to L3/RRC reconfiguration messages. The fundamental limitations for RRC signaling are as follows.

Limitations for RRC signaling may be associated with RRC reconfiguration messages being generally large because they may also convey indications of which one of the configurations should be maintained or released. For example, if 100 features are configured, RRC message may include 100 bits just to indicate that the UE 102 shall not release the configurations. Limitations for RRC signaling may be associated with reconfiguration messages including mandatory present information which may to be continuously transmitted even if it is not necessary. Limitations for RRC signaling may be associated with RRC messages traversing through several layers where each layer header further adds to the overhead.

Limitations for RRC signaling may be associated with RRC transactions that are (by design) kept as infrequent as possible to avoid adverse overhead and signaling load impacts which makes fast activation and deactivation very challenging from RRC layer.

In exceptional cases, activation and deactivation indications have been introduced to (EUTRA and NR) MAC control elements where an indicator bit may be associated with a RRC configured feature. It may be a much faster and more efficient (but as of today unprotected) mechanism than RRC signaling but: addition of activation and deactivation bits separately for some or all features may create excessive and unacceptable overhead on MAC layer e.g., 100 features would add 100 bits: extension of such indicator bits may further increase the overhead because header extensions are often built as full octets.

Therefore, conventional L3/RRC signaling solutions are slow, but much faster MAC control element indicator solutions are conventionally not a feasible and future-proof way forward even if L2 becomes secure.

Issue 3: How to handle system information overhead problems caused by digital signatures?

If digital signatures are added to every system information block, their encoding sizes may be on par with those of entire system information blocks because digital signatures are generally in the order tens of octets. There are clearly negative impacts on both broadcasting capacity and scheduling of system information because the increased SI and SIB encoding sizes, for example create restrictions on how many blocks may be scheduled for transmission at the same time. Conventionally, it is not clear how to resolve the issue of overhead caused by digital signatures in system information.

Disclosed herein are methods, systems, and devices that may assist in NR security enhancements. Disclosed herein are methods, systems, and devices that may help derive and select input parameters for security function in radio protocol stack. Disclosed herein are methods, systems, and devices that may address system performance by relocating security protection functions to lower layers of the radio protocol stack. Disclosed herein are methods, systems, and devices that may address overhead problems caused by authentication codes in broadcasted system information.

Herein, methods, systems, or devices may help derive and select input parameters for security function in radio protocol stack. A security protection function may be configured to protect radio protocol control information. The input parameters for the security algorithm may be obtained using the following approaches. In an approach, RRC may provide bearer ID parameter upon configuration of the protocol entity and the bearer ID of the protocol entity may be used as an input parameter for the security protection of control data units generated by the protocol entity. In an approach, a default bearer identity may be used as Bearer ID input parameter for the security protection of control data units. In an approach, a signaling bearer identity may be used as Bearer ID input parameter value for the security protection of control data units. In an approach, a fixed pre-defined value may be used as Bearer ID input parameter value for the security protection of control data units. In an approach, a configurable value may be used as Bearer ID input parameter value for the security protection of control data units. In an approach, a logical channel ID may be used as Bearer ID input parameter value for the security protection of control data units. In an approach, a cell ID may be used as Bearer ID input parameter value for the security protection of control data units. In an approach, a cell group ID may be used as Bearer ID input parameter value for the security protection of control data units. In an approach, a Quality of Service (QOS) flow ID may be used as Bearer ID input parameter value for the security protection of control data. In an approach, a PDU session ID may be used as Bearer ID input parameter value for the security protection of control data. In an approach, a Radio Network Temporary Identifier (RNTI) value may be used as Bearer ID input parameter value for the security protection of control data units. In an approach, a Transmission and Reception Point (TRP) ID may be used as Bearer ID input parameter value for the security protection of control data. In an approach, a Component Carrier (CC) ID may be used as Bearer ID input parameter value for the security protection of control data. In an approach, a beam ID or beam group ID may be used as Bearer ID input parameter value for the security protection of control data. In an approach, a Multiple Input Multiple Output (MIMO) layer ID may be used as Bearer ID input parameter value for the security protection of control data. In an approach, a sidelink (SL) source L1 ID as Bearer ID input parameter for protection of PDCP Control PDUs. In an approach, a sidelink (SL) destination L1 ID as Bearer ID input parameter for protection of PDCP Control PDUs.

In an approach, there may be a combination of two or more of the approaches described herein. For example, the bearer ID input parameter may be a concatenation of bearer ID and logical channel ID, concatenation of bearer ID and cell ID or cell group ID, a concatenation of logical channel ID and cell ID or cell group ID, or bearer ID, logical channel ID and cell ID or cell group ID.

In an approach, a RLC sequence number may be used as COUNT input parameter for the security protection of control data units.

With reference to security functions disclosed herein, a mobile device may report capabilities to support integrity protection or confidentiality protection on different protocol layers. The capabilities may be dynamically associated with security functions. For example, depending on trigger, environment, location, or RAT, among other things.

Methods, systems, or devices may address system performance by relocating security protection functions to lower layers of the radio protocol stack. A protocol field that may be composed of n bits. The bit combinations may be associated with radio interface features, that include operations such as: toggling feature status between activated and deactivated status upon reception of the bit combination: or sending a separate bit in conjunction with the bit combination to indicate activation status of the feature associated with the bit combination.

Methods, systems, or devices may address overhead problems caused by authentication codes in broadcasted system information. A mobile device, upon reception of system information, may have the following operations: appending system information messages or data blocks with an authentication code for integrity protection: discarding system information (e.g., broadcasted messages or data blocks) when the integrity check fails: discarding system information from a network node upon detection of failed integrity check of any of the broadcasted data units (e.g., messages or data blocks) within a period from the network node: or adding a network node to an excluded list and starting a timer, wherein the system information from the network node may not be acquired again until the timer expires. The system information may be broadcasted or relayed via another node in multihopping or sidelink (SL) deployments.

It is understood that the approaches described herein may apply to both uplink and downlink in the case of the Uu interface, and may also apply equally to both the Uu interface radio protocol as well as the sidelink (PC5) interface radio protocols, or the like.

As may be observed below; the subject matter is accounting for the possibility that the same function may be specified at different layers, and these different possibilities are covered herein. For example, for PDCP control PDU security protection, examples are considered in which this function may be implemented in PDCP, in RLC, or in MAC. As further described, the parameter bearer ID, for example, may be used in the encryption or integrity protection algorithm, may be derived the same way respectively, regardless of whether the functionality is implemented in PDCP, RLC, or MAC sublayer. It may also be assumed that this information may be configured into the sublayer where the functionality may be implemented. For example, for the protection of a PDCP control PDU generated by a PDCP entity instantiated for a given bearer, RRC may configure into PDCP, RLC, or MAC, the bearer ID to use in the algorithm for the security protection of the said PDCP control PDU, and such bearer ID may be the ID of the bearer that corresponds to the PDCP entity which generates the PDCP control PDU, depending on whether the security protection function is implemented in PDCP, RLC, or MAC. In another alternative, there may be inter-sublayer exchange for the conveying of the needed parameters for e.g., a PDCP entity associated with a given bearer may provide to RLC or MAC, the bearer ID for which this PDCP entity has been instantiated, so RLC or MAC can use this bearer ID in the algorithm for the security protection of a PDCP control PDU generated by the said PDCP entity.

The disclosed subject matter covers the possibility of the security protection function of a PDCP control PDU being implemented at any layer of the protocol stack (e.g., SDAP. PDCP, RLC, MAC, or PHY). This applies for the control PDU of any of the other layers. For example, a control PDU might be generated by a given layer (e.g., SDAP control PDU, PDCP control PDU, RLC control PDU MAC control PDU, PHY control PDU), and the security protection of that control PDU might be performed in the same layer that generates the control PDU, or at another layer that is different from the layer where the control PDU is generated.

### Security Functions in PDCP Layer.

The following approaches for security protection input parameter selection and derivation may be based on an assumption that security functions for control information protection reside in PDCP layer.

The PDCP Control PDUs may be ciphered or integrity protected by using the Bearer ID as an input parameter to security algorithms. The following approaches are possible for the Bearer ID parameter selection.

BEARER parameter—PDCP PDU Approach 1: RRC provides a Bearer ID upon the configuration of the PDCP entity in the RadioBearerConfig Information Element (IE). The PDCP entity may use the bearer ID associated with the PDCP entity for which a PDCP control PDU is being generated as an input parameter to the security algorithms.

BEARER parameter—PDCP Approach 2: A default bearer ID may be used as an input parameter for a PDCP control PDU protection. RRC provides information about a default bearer ID upon radio bearer configuration.

If the core network (CN) association is with 4G Evolved Packet System (EPS), the corresponding EPS bearer ID may be provided to configured DRBs in the instances of DRB-ToAddModList. The DRB instance that is configured with the EPS default bearer value, as provided by the NAS protocol, is the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

With continued to the reference BEARER parameter—PDCP Approach 2, if the CN association is with 5G Core network (5GC), the default bearer information is indicated in the DRB-ToAddModList. The DRB instance that is the default bearer conveys an indicator in the SDAP-Config IE where the field defaultDRB is set to value TRUE for the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

BEARER parameter—PDCP PDU Approach 3: Use SRB1 ID for PDCP control PDUs. RRC configures SRB1 ID value upon radio bearer configuration. RRC configures SRB1 ID value upon radio bearer configuration.

BEARER parameter—PDCP PDU Approach 4: Use SRB1 ID for PDCP control PDUs except for SRB2 PDCP related control PDU where SRB2 ID is used. RRC configures both SRB1 and SRB2 ID values upon radio bearer configuration.

BEARER parameter—PDCP PDU Approach 5: Use a fixed pre-defined default value as Bearer ID input parameter for PDCP Control PDUs of one or more PDCP entities. The fixed value may be captured in the specifications. More than one fixed pre-defined values may be defined.

BEARER parameter—PDCP PDU Approach 6: Use a configurable value as Bearer ID input parameter for PDCP Control PDUs of one or more PDCP entities. RRC can explicitly configure a Bearer ID value to be used for security protection of PDCP Control PDUs of one or more PDCP entities upon radio bearer configuration. The value may be introduced as a protocol extension.

BEARER parameter—PDCP PDU Approach 7: Use the ID of the logical channel, i.e. LCID, where the PDCP data may be mapped to as Bearer ID input parameter for protection of PDCP Control PDUs.

BEARER parameter—PDCP PDU Approach 8: Use the ID of the cell or cell group, where the PDCP data may be mapped to as Bearer ID input parameter for protection of PDCP Control PDUs. BEARER parameter—PDCP PDU Approach 9: All its bits set to 0). BEARER parameter—PDCP PDU Approach 10: All its bits set to 1.

BEARER parameter—PDCP PDU Approach 11: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

RLC control PDUs for e.g., the RLC status PDUs are security protected by using ciphering or integrity protection functions at the PDCP layer. In other words, at the sender side, the PDCP entity that maps bearer data to a RLC entity may be used for ciphering or integrity protection of the RLC status PDUs generated by this RLC entity. The PDCP entity processes the RLC status PDUs by using the following approaches for Bearer ID parameter selection.

BEARER parameter—RLC PDU Approach 1: Re-use the same Bearer ID derivation methods described for the case of security protection of PDCP control PDUs. In other words, for a PDCP control PDU generated by a given RLC entity, use the same Bearer ID input parameter as for the PDCP entity mapped to this RLC entity, e.g., derive the Bearer ID input parameter in the same manner as for the protection of the PDCP control PDUs generated by the PDCP entity mapped to this RLC entity, e.g., the PDCP entity whose SDUs are transferred via this RLC entity. This approach may be a prime candidate approach for example for the scenarios where there is one-to-one mapping, e.g., association between PDCP entity and RLC entity.

BEARER parameter—RLC PDU Approach 2: Re-use similar Bearer ID derivation methods described for the case of security protection of PDCP control PDUs. As for the bearer ID input parameter derivation is for a specific RLC entity contact, the Bearer ID input parameter may be same or may be different from the bearer ID input used for the security protection of PDCP control PDU generated by the PDCP entity associated with the RLC entity that generated the RLC control PDU. Several sub-approaches may be considered.

BEARER parameter—RLC PDU Approach 2-1: Use a fixed pre-defined default value as Bearer ID input parameter for RLC Control PDUs of one or more RLC entities. The fixed value may be captured in the specifications. More than one fixed pre-defined values may be defined.

BEARER parameter—RLC PDU Approach 2-2: Use a configurable value as Bearer ID input parameter for the security protection of RLC Control PDUs of one or more PDCP entities. RRC can explicitly configure a Bearer ID value to be used for security protection of RLC Control PDUs of one or more RLC entities during radio bearer configuration. The value may be introduced as a protocol extension. Several configurable values may be configured to the UE 102 as bearer ID input parameter for the security protection of RLC Control PDUs, with each value associated with one or more RLC entities. RRC may provide the configurable bearer ID input parameter to the UE 102 in RLC-BearerConfig-IE during radio bearer configuration.

BEARER parameter—RLC PDU Approach 2-3: Use the ID of a logical channel, i.e. the LCID associated with a RLC entity that generates a control PDU as Bearer ID input parameter for the security protection of the RLC Control PDU. For a given RLC entity. RRC provides LCID to the UE 102 during RLC configuration in RLC-BearerConfig IE, as part of radio bearer configuration.

BEARER parameter—RLC PDU Approach 2-4: Use the ID of a cell or a cell group, e.g., the cell or group of cells where a RLC entity that generates a RLC control PDU may be mapped to, as Bearer ID input parameter for protection of the RLC Control PDU. RRC provides each cell group in the UE 102, an ID during configuration of the cell group in CellGroupConfig IE. There are several possible alternatives for this approach. For Approach 2-4, the Cell Group ID parameter may be used as Bearer ID input parameter. If 5 bits input parameter is needed, use zero padding to provide 5 bits Bearer ID. The outcome of padding may be used as Bearer ID input parameter. For Approach 2-4, the Bearer ID parameter may be obtained from concatenation of the Bearer ID that is configured to the RLC entity with Cell Group ID. If 5 bits input parameter is needed, use LSBs or MSBs of Bearer ID concatenated with Cell Group ID. The outcome of concatenation may be used as Bearer ID input parameter. For Approach 2-4, the Bearer ID parameter may be obtained from concatenation of the LCID that is configured to the RLC entity with Cell Group ID. If 5 bits input parameter is needed, Bearer ID parameter may be obtained from concatenation of 3 LSB bits or 3 MSB bits of the LCID that is configured to the RLC entity with 2 bits Cell Group ID.

BEARER parameter—RLC PDU Approach 2-5: All its bits set to 0. BEARER parameter—RLC PDU Approach 2-6: All its bits set to 1. BEARER parameter—RLC PDU Approach 2-7: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

If BEARER parameter—RLC PDU Approach 1 is not used, the RLC entity provides the Bearer ID parameter to the PDCP entity for processing of the RLC Control PDU. After processing, the ciphering units and authentication codes of the PDUs are returned back to the RLC entity where they are included in the RLC status PDUs.

At the receiving side, a reverse operation is carried out. The message contents and ciphering units of RLC status PDUs may be sent to the PDCP layer. The PDCP entity that may be used for mapping of bearer data from RLC entities may be used for computation of authentication codes and deciphered data. After processing, the PDCP entity returns back to the RLC entity deciphered data and the output of the integrity protection algorithm.

MAC Control PDU Protection. MAC Control Elements (CEs) are security protected by using ciphering or integrity protection functions at the PDCP layer.

At the sender side, the MAC entity forwards MAC CEs to RLC layer where the CEs are further sent to PDCP layer. The RLC entity that maps data to the Logical Channel (LCH) may be used for the routing of the MAC CEs to the PDCP layer. The PDCP entity that maps bearer data to the RLC entity may be used for ciphering or integrity protection of the MAC CEs. The PDCP entity processes the MAC CEs by using the following approaches for Bearer ID parameter selection.

BEARER parameter—MAC PDU Approach 1: Use the same Bearer ID input parameter for MAC CEs as may be used for the security protection of PDCP control PDUs on the PDCP layer.

BEARER parameter—MAC PDU Approach 2: Use the LCID of the LCH where the MAC CEs are to be transferred as Bearer ID input parameter. RRC provides LCIDs upon MAC logical channel configuration in RLC-BearerConfig IE.

BEARER parameter—MAC PDU Approach 3: The Bearer ID input parameter may be derived from Cell Group IDs. RRC provides each cell group an ID upon configuration of the cell group in CellGroupConfig IE. There are several possible alternatives for this approach. For MAC PDU Approach 3, the Cell Group ID parameter may be used as Bearer ID input parameter. If 5 bits input parameter is needed, use zero padding to provide 5 bits Bearer ID. The outcome of padding may be used as Bearer ID input parameter. For MAC PDU Approach 3, the Bearer ID parameter may be obtained from concatenation of the Bearer ID that is configured to the RLC entity with Cell Group ID. If 5 bits input parameter is needed, use LSBs or MSBs of Bearer ID concatenated with Cell Group ID. The outcome of concatenation may be used as Bearer ID input parameter. For MAC PDU Approach 3, the Bearer ID parameter may be obtained from concatenation of the LCID that is configured to the RLC entity with Cell Group ID. If 5 bits input parameter is needed, Bearer ID parameter may be obtained from concatenation of 3 LSB bits or 3 MSB bits of the LCID that is configured to the RLC entity with 2 bits Cell Group ID.

BEARER parameter—MAC PDU Approach 4: RRC configures explicitly a new MAC layer parameter to be used as Bearer ID input parameter for security protection. BEARER parameter—MAC PDU Approach 5: All its bits set to 0. BEARER parameter—MAC PDU Approach 6: All its bits set to 1.

If BEARER parameter—MAC PDU Approach 1 is not used, the MAC entity provides the Bearer ID parameter to the PDCP entity for processing of the MAC CEs. After processing, the PDCP entity returns the data back to the MAC entity. The MAC entity includes the ciphered MAC CEs and the authentication codes to MAC PDUs.

At the receiving side, a reverse operation is performed by routing the MAC CEs via RLC to PDCP layer for processing and then back to MAC layer. The CE contents and ciphering units of MAC PDUs may be sent to the RLC entity and then further to the PDCP entity that maps bearer data to the RLC entity. The PDCP entity may be used for computation of authentication codes and deciphering of data. After processing, the PDCP entity returns back to the RLC entity deciphered data and the output of the integrity protection algorithm whereof it is further transferred to the MAC entity.

PHY Control PDU or Signal Protection. Physical layer control information may be security protected by using ciphering or integrity protection functions at the PDCP layer.

At the sender side, the PHY entity forwards control PDUs via MAC and RLC layer where the control data us further sent to PDCP layer. The RLC entity that maps data to the Logical Channel (LCH) may be used for the routing of the PHY control information to the PDCP layer. The PDCP entity that maps bearer data to the RLC entity may be used for ciphering or integrity protection of the PHY control information. The PDCP entity processes the PHY control information by using the following approaches for Bearer ID parameter selection.

BEARER parameter—PHY PDU Approach 1: Use the same Bearer ID input parameter for PHY control information as may be used for the security protection of PDCP control PDUs on the PDCP layer.

BEARER parameter—PHY PDU Approach 2: Use Radio Network Temporary Identifier (RNTI) value as Bearer ID input parameter. RRC provides RNTI values upon physical cell group configuration in PhysicalCellGroupConfig IE. If 5 bits input parameter is needed use MSB or LSB of RNTI value.

BEARER parameter—PHY PDU Approach 3: The Cell Group ID parameter may be used as Bearer ID input parameter. If 5 bits input parameter is needed, use zero padding to provide 5 bits Bearer ID. The outcome of padding may be used as Bearer ID input parameter.

BEARER parameter—PHY PDU Approach 4: Use a concatenation of Radio Network Temporary Identifier (RNTI) value with Cell Group ID. If 5 bits input parameter is needed, use MSB or LSB of RNTI value of RNTI concatenated with Cell Group ID: or Cell Group ID or concatenated with MSB or LSB of RNTI value of RNTI.

BEARER parameter—PHY PDU Approach 5: RRC configures explicitly a new PHY layer parameter to be used as Bearer ID input parameter for security protection. BEARER parameter—PHY PDU Approach 6: All its bits set to 0. BEARER parameter—PHY PDU Approach 7: All its bits set to 1.

If BEARER parameter—PHY PDU Approach 1 is not used, the PHY entity provides the Bearer ID parameter to the PDCP entity for processing of the PHY control information. After processing, the PDCP entity returns the data back to the RLC entity whereof the data is further passed to the PHY layer via MAC entity. The PHY layer may include the ciphered control information and the authentication codes to transport blocks.

At the receiving side, a reverse operation is performed by routing the PHY control information via MAC and RLC to PDCP layer for processing and then back to PHY layer. The control information contents and ciphering units of PHY control PDUs may be sent to the MAC and RLC entities and further to the PDCP entity that maps bearer data to the RLC entity. The PDCP entity may be used for computation of authentication codes and deciphering of data. After processing, the PDCP entity returns back to the RLC entity deciphered data and the output of the integrity protection algorithm whereof it is further transferred to the PHY layer via MAC entity.

The PDCP layer uses the COUNT value associated with the PDCP entity for which a PDCP control PDU is being generated as an input parameter to the security algorithms. Alternatively, it may use default bearer COUNT value as an input parameter for PDCP control PDUs only. Another approach is to use the COUNT value for SRB1 for PDCP control PDUs except for SRB2 PDCP related control PDU where the COUNT value for SRB2 is used.

The RLC control PDUs are transferred in Acknowledged Mode (AM) with 12 or 18 bits sequence number. The following approaches are possible.

COUNT parameter-RLC PDU Approach 1: The RLC entity can use RLC Sequence Number (SN) as the COUNT input parameter to security protection algorithms.

COUNT parameter-RLC PDU Approach 2: The sequence number space may be extended to be on par with PDCP layer's 32 bits COUNT by introducing a control PDU specific SN extension with 20 or 14 bits. In that case, the COUNT value may be a concatenation of ordinary RLC SN and the sequence control PDU specific SN extension. The RLC status PDU specific SN value may be increased only for RLC control PDUs.

The RLC COUNT value may be provided to PDCP layer when RLC status PDUs may be sent to PDCP for ciphering or integrity protection.

MAC PDU may be appended with a 32 bits SN to be used as COUNT input parameter for security protection algorithms. The following approaches are possible.

COUNT parameter-MAC PDU Approach 1: MAC PDU specific COUNT may be derived from MAC SN where the same SN is used as COUNT input parameter to MAC CEs within the same MAC PDU.

COUNT parameter-MAC PDU Approach 2: MAC subPDU specific COUNT may be derived from MAC subPDU specific SN which is used as COUNT input parameter to such MAC CEs that are used for the same LCH.

The MAC COUNT values are provided to PDCP layer when MAC CEs are sent to PDCP for ciphering, deciphering, or integrity protection.

PHY Control PDU or Signal Protection. PHY PDU may be appended with a 32 bits SN to be used as COUNT input parameter for security protection algorithms. Transport Block (TB) specific COUNT may be derived from PHY SN where the same SN is used as COUNT input parameter to control information within the same TB. The following approaches are possible.

COUNT parameter-PHY PDU Approach 1: PHY PDU specific COUNT may be derived from PHY SN where the same SN is used as COUNT input parameter to control information within the same TB.

COUNT parameter-PHY PDU Approach 2: PHY PDU specific COUNT may be derived from PHY SN where the same SN is used as COUNT input parameter to control information within the same physical layer frame.

The PHY COUNT value may be provided to PDCP layer when PHY control information is sent to PDCP for ciphering, deciphering, or integrity protection.

Message parameter. The content of the PDCP Control PDU may be provided as an input to the integrity protection algorithm. The algorithm computes an authentication code and the PDCP entity adds the code to the PDCP Control PDU. The PDCP Control PDU conveys an authentication code.

Message parameter. The content of the RLC Control PDU may be provided as an input to the integrity protection algorithm. The content may be sent to PDCP entity where the entity computes an authentication code. After the computation, the code may be sent from the PDCP entity to the RLC entity. The RLC entity adds the authentication code to the RLC Control PDU. The RLC Control PDU conveys an authentication code.

The content of the MAC CE may be provided as an input to the integrity protection algorithm. The content may be sent to PDCP entity via RLC layer and the PDCP entity computes an authentication code. After the computation, the code may be sent from the PDCP entity to the MAC entity via RLC layer. The MAC entity adds the authentication code to the MAC PDU. The following approaches are possible to address MAC PDU or MAC subPDU integrity.

MESSAGE parameter-MAC PDU Approach 1: MAC PDU specific authentication code may be derived by using a concatenation of MAC CEs that are to be transferred with the same MAC PDU as an input to the integrity protection algorithm. The authentication code may be computed by the PDCP layer and added in the same MAC PDU where the MAC CEs may be transferred. The MAC PDU format conveys an authentication code.

MESSAGE parameter-MAC PDU Approach 2: MAC subPDU specific authentication code may be derived by using a concatenation of such MAC CEs that are to be transferred within the same MAC subPDU as an input to the integrity protection algorithm. The authentication code may be computed by the PDCP layer and added in the MAC subPDU where the MAC CEs may be transferred. The MAC subPDU format conveys an authentication code.

The content of the PHY Control information may be provided as an input to the integrity protection algorithm. The content may be sent to PDCP entity where the PDCP entity computes an authentication code. After the computation, the code may be sent from the PDCP entity to the PHY entity. The PHY entity adds the authentication code to the PHY Control PDU which may be any PHY layer data unit. The following approaches are possible to address TB or frame-level integrity.

MESSAGE parameter-PHY PDU Approach 1: TB specific authentication code may be derived by using a concatenation of control information that is to be transferred with the same TB as an input to the integrity protection algorithm. The authentication code may be computed by the PDCP layer and added in the same TB where the control information is transferred. The TB format conveys an authentication code.

MESSAGE parameter-PHY PDU Approach 2: Frame specific authentication code may be derived by using a concatenation of control information that is to be transferred within the same frame as an input to the integrity protection algorithm. The authentication code may be computed by the PDCP layer and added in the frame where the control information is transferred. The frame structure and format convey an authentication code.

### Security Functions in RLC Layer.

The following approaches for security protection input parameter selection and derivation may be based on the assumption that security functions for control information protection reside in RLC layer.

The PDCP Control PDU may be submitted to the RLC layer. The following approaches are possible for the Bearer ID parameter selection.

BEARER parameter—PDCP PDU Approach 1: RRC provides a Bearer ID upon the configuration of the PDCP entity in the RadioBearerConfig Information Element (IE). The RLC entity uses the bearer ID associated with the PDCP entity for which a PDCP control PDU is being generated as an input parameter to the security algorithms.

BEARER parameter—PDCP PDU Approach 2: A default bearer ID may be used as an input parameter for a PDCP control PDU protection. RRC provides information about a default bearer ID upon radio bearer configuration.

Further with regard to Approach 2, if the core network (CN) association is with 4G Evolved Packet System (EPS), the corresponding EPS bearer ID may be provided to configured DRBs in the instances of DRB-ToAddModList. The DRB instance that is configured with the EPS default bearer value, as provided by the NAS protocol, is the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

Further with regard to Approach 2, if the CN association is with 5G Core network (5GC), the default bearer information is indicated in the DRB-ToAddModList. The DRB instance that is the default bearer conveys an indicator in the SDAP-Config IE where the field defaultDRB is set to value TRUE for the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

BEARER parameter—PDCP PDU Approach 3: Use SRB1 ID for PDCP control PDUs. RRC configures SRB1 ID value upon radio bearer configuration. RRC configures SRB1 ID value upon radio bearer configuration.

BEARER parameter—PDCP PDU Approach 4: Use SRB1 ID for PDCP control PDUs except for SRB2 PDCP related control PDU where SRB2 ID is used. RRC configures both SRB1 and SRB2 ID values upon radio bearer configuration.

BEARER parameter—PDCP PDU Approach 5: Use a fixed pre-defined default value as Bearer ID input parameter for PDCP Control PDUs of one or more PDCP entities. The fixed value may be captured in the specifications. More than one fixed pre-defined values may be defined.

BEARER parameter—PDCP PDU Approach 6: Use a configurable value as Bearer ID input parameter for PDCP Control PDUs of one or more PDCP entities. RRC can explicitly configure a Bearer ID value to be used for security protection of PDCP Control PDUs of one or more PDCP entities upon radio bearer configuration. The value may be introduced as a protocol extension.

BEARER parameter—PDCP PDU Approach 7: Use the ID of the logical channel, e.g., LCID, where the PDCP data may be mapped to as Bearer ID input parameter for protection of PDCP Control PDUs.

BEARER parameter—PDCP PDU Approach 8: Use the ID of the cell or cell group, where the PDCP data may be mapped to as Bearer ID input parameter for protection of PDCP Control PDUs. BEARER parameter—PDCP PDU Approach 9: All its bits set to 0). BEARER parameter—PDCP PDU Approach 10: All its bits set to 1.

BEARER parameter—PDCP PDU Approach 11: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

### RLC Control PDU Protection

RLC control PDUs for e.g. the RLC status PDUs are security protected by using ciphering or integrity protection functions at the PDCP layer. In other words, at the sender side, the PDCP entity that maps bearer data to a RLC entity may be used for ciphering or integrity protection of the RLC status PDUs generated by this RLC entity. The PDCP entity processes the RLC status PDUs by using the following approaches for Bearer ID parameter selection.

BEARER parameter—RLC PDU Approach 1: Re-use the same Bearer ID derivation methods described for the case of security protection of PDCP control PDUs. In other words, for a PDCP control PDU generated by a given RLC entity, use the same Bearer ID input parameter as for the PDCP entity mapped to this RLC entity, e.g., derive the Bearer ID input parameter in the same manner as for the protection of the PDCP control PDUs generated by the PDCP entity mapped to this RLC entity e.g., the PDCP entity whose SDUs are transferred via this RLC entity.—This approach may be a prime candidate approach for example for the scenarios where there is one-to-one mapping e.g., association between PDCP entity and RLC entity.

BEARER parameter—RLC PDU Approach 2: Re-use similar Bearer ID derivation methods described for the case of security protection of PDCP control PDUs. As for the bearer ID input parameter derivation is for a specific RLC entity contact, the Bearer ID input parameter may be same or may be different from the bearer ID input used for the security protection of PDCP control PDU generated by the PDCP entity associated with the RLC entity that generated the RLC control PDU. Several sub-approaches may be considered.

BEARER parameter—RLC PDU Approach 2-1: Use a fixed pre-defined default value as Bearer ID input parameter for RLC Control PDUs of one or more RLC entities. The fixed value may be captured in the specifications. More than one fixed pre-defined values may be defined.

BEARER parameter—RLC PDU Approach 2-2: Use a configurable value as Bearer ID input parameter for the security protection of RLC Control PDUs of one or more PDCP entities. RRC can explicitly configure a Bearer ID value to be used for security protection of RLC Control PDUs of one or more RLC entities during radio bearer configuration. The value may be introduced as a protocol extension. Several configurable values may be configured to the UE 102 as bearer ID input parameter for the security protection of RLC Control PDUs, with each value associated with one or more RLC entities. RRC may provide the configurable bearer ID input parameter to the UE 102 in RLC-BearerConfig-IE during radio bearer configuration.

BEARER parameter—RLC PDU Approach 2-3: Use the ID of a logical channel, i.e. the LCID associated with a RLC entity that generates a control PDU as Bearer ID input parameter for the security protection of the RLC Control PDU. For a given RLC entity. RRC provides LCID to the UE 102 during RLC configuration in RLC-BearerConfig IE, as part of radio bearer configuration.

BEARER parameter—RLC PDU Approach 2-4: Use the ID of a cell or a cell group, e.g., the cell or group of cells where a RLC entity that generates a RLC control PDU may be mapped to, as Bearer ID input parameter for protection of the RLC Control PDU. RRC provides each cell group in the UE 102, an ID during configuration of the cell group in CellGroupConfig IE. There are several possible alternatives for this Approach 2-4.

For Approach 2-4, the Cell Group ID parameter may be used as Bearer ID input parameter. If 5 bits input parameter is needed, use zero padding to provide 5 bits Bearer ID. The outcome of padding may be used as Bearer ID input parameter.

For Approach 2-4, the Bearer ID parameter may be obtained from concatenation of the Bearer ID that is configured to the RLC entity with Cell Group ID. If 5 bits input parameter is needed, use LSBs or MSBs of Bearer ID concatenated with Cell Group ID. The outcome of concatenation may be used as Bearer ID input parameter.

For Approach 2-4, the Bearer ID parameter may be obtained from concatenation of the LCID that is configured to the RLC entity with Cell Group ID. If 5 bits input parameter is needed. Bearer ID parameter may be obtained from concatenation of 3 LSB bits or 3 MSB bits of the LCID that is configured to the RLC entity with 2 bits Cell Group ID.

BEARER parameter—RLC PDU Approach 2-5: All its bits set to 0. BEARER parameter—RLC PDU Approach 2-6: All its bits set to 1.

BEARER parameter—RLC PDU Approach 2-7: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

If BEARER parameter—RLC PDU Approach 1 is not used, the RLC entity provides the Bearer ID parameter to the PDCP entity for processing of the RLC Control PDU. After processing, the ciphering units and authentication codes of the PDUs are returned back to the RLC entity where they are included in the RLC status PDUs.

At the receiving side, a reverse operation is carried out. The message contents and ciphering units of RLC status PDUs may be sent to the PDCP layer. The PDCP entity that may be used for mapping of bearer data from RLC entities may be used for computation of authentication codes and deciphered data. After processing, the PDCP entity returns back to the RLC entity deciphered data and the output of the integrity protection algorithm.

### MAC Control PDU Protection

MAC Control Elements (CEs) are security protected by using ciphering or integrity protection functions at the RLC layer.

At the sender side, the MAC entity forwards MAC CEs to RLC layer. The RLC entity that maps data to the Logical Channel (LCH) may be used for ciphering or integrity protection of the MAC CEs.

The RLC entity processes the MAC CEs by using the following approaches for Bearer ID parameter selection.

BEARER parameter—MAC PDU Approach 1: Use the same Bearer ID input parameter for MAC CEs as may be used for the security protection of RLC control PDUs on the RLC layer.

BEARER parameter—MAC PDU Approach 2: Use the LCID of the LCH where the MAC CEs are to be transferred as Bearer ID input parameter. RRC provides LCIDs upon MAC logical channel configuration in RLC-BearerConfig IE.

BEARER parameter—MAC PDU Approach 3: The Bearer ID input parameter may be derived from Cell Group IDs. RRC provides each cell group an ID upon configuration of the cell group in CellGroupConfig IE. There are several possible alternatives for this Approach 3.

For Approach 3, the Cell Group ID parameter may be used as Bearer ID input parameter. If 5 bits input parameter is needed, use zero padding to provide 5 bits Bearer ID. The outcome of padding may be used as Bearer ID input parameter.

For Approach 3, Bearer ID parameter may be obtained from concatenation of the Bearer ID that is configured to the MAC entity with Cell Group ID. If 5 bits input parameter is needed, use LSBs or MSBs of Bearer ID concatenated with Cell Group ID. The outcome of concatenation may be used as Bearer ID input parameter.

For Approach 3, Bearer ID parameter may be obtained from concatenation of the LCID that is configured to the MAC entity with Cell Group ID. If 5 bits input parameter is needed, Bearer ID parameter may be obtained from concatenation of 3 LSB bits or 3 MSB bits of the LCID that is configured to the RLC entity with 2 bits Cell Group ID.

BEARER parameter—MAC PDU Approach 4: RRC configures explicitly a new MAC layer parameter to be used as Bearer ID input parameter for security protection. BEARER parameter—MAC PDU Approach 5: All its bits set to 0. BEARER parameter—MAC PDU Approach 6: All its bits set to 1.

If BEARER parameter—MAC PDU Approach 1 is not used, the MAC entity provides the Bearer ID parameter to the RLC entity for processing of the MAC CEs. After processing, the RLC entity returns the data back to the MAC entity. The MAC entity includes the ciphered MAC CEs and the authentication codes to MAC PDUs.

At the receiving side, a reverse operation is performed by routing the MAC CEs to RLC layer for processing and then back to MAC layer. The CE contents and ciphering units of MAC PDUs may be sent to the RLC entity. The RLC entity may be used for computation of authentication codes and deciphering of data by using the same Bearer ID that may be used for security protected RLC and PDCP Control PDUs. After processing, the RLC entity returns back to the MAC entity deciphered data and the output of the integrity protection algorithm.

Physical layer control information may be security protected by using ciphering or integrity protection functions at the RLC layer.

At the sender side, the PHY entity forwards control PDUs via MAC to the RLC entity for ciphering or integrity protection of the PHY control information. The RLC entity processes the PHY control information by using the following approaches for Bearer ID parameter selection.

BEARER parameter—PHY PDU Approach 1: Use the same Bearer ID input parameter for PHY control information as may be used for the security protection of RLC and PDCP control PDUs.

BEARER parameter—PHY PDU Approach 2: Use Radio Network Temporary Identifier (RNTI) value as Bearer ID input parameter. RRC provides RNTI values upon physical cell group configuration in PhysicalCellGroupConfig IE. If 5 bits input parameter is needed use MSB or LSB of RNTI value.

BEARER parameter—PHY PDU Approach 3: The Cell Group ID parameter may be used as Bearer ID input parameter. If 5 bits input parameter is needed, use zero padding to provide 5 bits Bearer ID. The outcome of padding may be used as Bearer ID input parameter.

BEARER parameter—PHY PDU Approach 4: Use a concatenation of Radio Network Temporary Identifier (RNTI) value with Cell Group ID. If 5 bits input parameter is needed, use MSB or LSB of RNTI value of RNTI concatenated with Cell Group ID: or Cell Group ID or concatenated with MSB or LSB of RNTI value of RNTI.

BEARER parameter—PHY PDU Approach 5: RRC configures explicitly a new PHY layer parameter to be used as Bearer ID input parameter for security protection. BEARER parameter—PHY PDU Approach 6: All its bits set to 0. BEARER parameter—PHY PDU Approach 7: All its bits set to 1.

If BEARER parameter—PHY PDU Approach 1 is not used, the PHY entity provides the Bearer ID parameter to the RLC entity for processing of the PHY control information. After processing, the RLC entity returns the data back to the MAC entity whereof the data is further passed to the PHY layer the PHY layer may include the ciphered control information and the authentication codes to transport blocks.

At the receiving side, a reverse operation is performed by routing the PHY control information via MAC and RLC and then back to PHY layer. The control information contents and ciphering units of PHY control PDUs may be sent to the RLC entity. The RLC entity may be used for computation of authentication codes and deciphering of data. After processing, the RLC entity returns back to the MAC entity deciphered data and the output of the integrity protection algorithm whereof it is further transferred to the PHY layer.

Count parameter. The PDCP Control may be submitted to the RLC layer where the RLC COUNT value is used as an input to security protection algorithms. The derivation and maintenance of the RLC COUNT value may be hidden to PDCP layer.

The RLC control PDUs are transferred in Acknowledged Mode (AM) with 12 or 18 bits sequence number. The following approaches are possible.

COUNT parameter-PDCP PDU Approach 1: The RLC entity can use RLC Sequence Number (SN) as the COUNT input parameter to security protection algorithms.

COUNT parameter-PDCP PDU Approach 2: The sequence number space may be extended to be on par with PDCP layer's 32 bits COUNT by introducing a control PDU specific SN extension with 20 or 14 bits. In that case, the COUNT value may be a concatenation of ordinary RLC SN and the sequence control PDU specific SN extension. The RLC status PDU specific SN value may be increased only for RLC control PDUs.

The RLC COUNT value is used an input parameter to security algorithms for the ciphering or integrity protection of PDCP and RLC Control PDUs.

MAC PDU may be appended with a 32 bits SN to be used as COUNT input parameter for security protection algorithms. The following approaches are possible.

COUNT parameter-MAC PDU Approach 1: MAC PDU specific COUNT may be derived from MAC SN where the same SN is used as COUNT input parameter to MAC CEs within the same MAC PDU.

COUNT parameter-MAC PDU Approach 2: MAC subPDU specific COUNT may be derived from MAC subPDU specific SN which is used as COUNT input parameter to such MAC CEs that are used for the same LCH.

The MAC COUNT values are provided to RLC layer when MAC CEs are sent to RLC for ciphering, deciphering, or integrity protection.

PHY PDU may be appended with a 32 bits SN to be used as COUNT input parameter for security protection algorithms. Transport Block (TB) specific COUNT may be derived from PHY SN where the same SN is used as COUNT input parameter to control information within the same TB. The following approaches are possible.

COUNT parameter-PHY PDU Approach 1: PHY PDU specific COUNT may be derived from PHY SN where the same SN is used as COUNT input parameter to control information within the same TB.

COUNT parameter-PHY PDU Approach 2: PHY PDU specific COUNT may be derived from PHY SN where the same SN is used as COUNT input parameter to control information within the same physical layer frame.

The PHY COUNT value may be provided to RLC layer when PHY control information is sent to RLC for ciphering, deciphering, or integrity protection.

Message parameter. In order to provide PDCP Control PDU content to the RLC layer, the lower layer needs to know which one of the submitted PDCP PDUs are control PDUs that are subject to security protection. There are several approaches to pass this kind of information to RLC layer.

MESSAGE parameter-PDCP PDU Approach 1: The PDCP Service Data (SDU) submitted to RLC layer contains a protocol discriminator field. The discriminator field may carry a bit that indicates whether the PDCP SDU is a Control PDU or not. The RLC layer uses the content of such PDUs where the discriminator indicates Control PDU content as an input parameter to the security protection algorithm.

MESSAGE parameter-PDCP PDU Approach 2: The RLC layer provides a secure data transfer Service Access Point (SAP) towards PDCP layer. Only PDCP Control PDUs may be submitted to RLC layer via the secure SAP. The RLC layer uses the content of such PDUs that may be submitted via the secure SAP as an input parameter to the security protection algorithm.

MESSAGE parameter-PDCP PDU Approach 3: All bearers may be configured with at least two RLC entities where one of the entities are intended to be used for the transfer of PDCP Control PDUs in a secure manner. The RLC layer uses the content of such PDCP SDUs that may be submitted to the secure data transfer RLC entity as an input parameter to the security protection algorithm.

The content of the RLC Control PDU may be provided as an input to the integrity protection algorithm. The algorithm computes an authentication code and adds the code to the RLC Control PDU. The RLC Control PDU conveys an authentication code.

The submitted PDCP Control PDU content may be provided as an input to the integrity protection algorithm. The algorithm computes an authentication code and adds the code to the RLC PDU that transfers the PDCP Control PDU. The RLC PDU conveys an authentication code.

The content of the MAC CE may be provided as an input to the integrity protection algorithm. The content may be sent to the RLC layer where the RLC entity computes an authentication code. After the computation, the code may be sent from the RLC entity to the MAC entity. The MAC entity adds the authentication code to the MAC PDU. The following approaches are possible to address MAC PDU or MAC subPDU integrity.

MESSAGE parameter-MAC PDU Approach 1: MAC PDU specific authentication code may be derived by using a concatenation of MAC CEs that are to be transferred with the same MAC PDU as an input to the integrity protection algorithm. The authentication code may be computed by the RLC layer and added in the same MAC PDU where the MAC CEs may be transferred. The MAC PDU format conveys an authentication code.

MESSAGE parameter-MAC PDU Approach 2: MAC subPDU specific authentication code may be derived by using a concatenation of such MAC CEs that are to be transferred within the same MAC subPDU as an input to the integrity protection algorithm. The authentication code may be computed by the RLC layer and added in the MAC subPDU where the MAC CEs may be transferred. The MAC subPDU format conveys an authentication code.

PHY Control PDU or Signal Protection. The content of the PHY Control information may be provided as an input to the integrity protection algorithm. The content may be sent to RLC entity and the RLC entity computes an authentication code. After the computation, the code may be sent from the RLC entity to the PHY entity. The PHY entity adds the authentication code to the PHY Control PDU which may be any PHY layer data unit. The following approaches are possible to address TB or frame-level integrity.

MESSAGE parameter-PHY PDU Approach 1: TB specific authentication code may be derived by using a concatenation of control information that is to be transferred with the same TB as an input to the integrity protection algorithm. The authentication code may be computed by the RLC layer and added in the same TB where the control information is transferred. The TB format conveys an authentication code.

MESSAGE parameter-PHY PDU Approach 2: Frame specific authentication code may be derived by using a concatenation of control information that is to be transferred within the same frame as an input to the integrity protection algorithm. The authentication code may be computed by the RLC layer and added in the frame where the control information is transferred. The frame structure and format convey an authentication code.

### Security Functions in MAC Layer

The following approaches for security protection input parameter selection and derivation may be based on the assumption that security functions for control information protection reside in MAC layer.

The PDCP Control PDUs may be ciphered or integrity protected by using the Bearer ID as an input parameter to security algorithms. The following approaches are possible for the Bearer ID parameter selection.

BEARER parameter—PDCP PDU Approach 1: RRC provides a Bearer ID upon the configuration of the PDCP entity in the RadioBearerConfig Information Element (IE). The MAC entity may use the bearer ID associated with the PDCP entity for which a PDCP control PDU is being generated as an input parameter to the security algorithms.

BEARER parameter—PDCP PDU Approach 2: A default bearer ID may be used as an input parameter for a PDCP control PDU protection. RRC provides information about a default bearer ID upon radio bearer configuration.

For Approach 2, if the core network (CN) association is with 4G Evolved Packet System (EPS), the corresponding EPS bearer ID may be provided to configured DRBs in the instances of DRB-ToAddModList. The DRB instance that is configured with the EPS default bearer value, as provided by the NAS protocol, is the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

For Approach 2, if the CN association is with 5G core network (5GC), the default bearer information is indicated in the DRB-ToAddModList. The DRB instance that is the default bearer conveys an indicator in the SDAP-Config IE where the field defaultDRB is set to value TRUE for the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

BEARER parameter—PDCP PDU Approach 3: Use SRB1 ID for PDCP control PDUs. RRC configures SRB1 ID value upon radio bearer configuration. RRC configures SRB1 ID value upon radio bearer configuration.

BEARER parameter—PDCP PDU Approach 4: Use SRB1 ID for PDCP control PDUs except for SRB2 PDCP related control PDU where SRB2 ID is used. RRC configures both SRB1 and SRB2 ID values upon radio bearer configuration.

BEARER parameter—PDCP PDU Approach 5: Use a fixed pre-defined default value as Bearer ID input parameter for PDCP Control PDUs of one or more PDCP entities. The fixed value may be captured in the specifications. More than one fixed pre-defined values may be defined.

BEARER parameter—PDCP PDU Approach 6: Use a configurable value as Bearer ID input parameter for PDCP Control PDUs of one or more PDCP entities. RRC can explicitly configure a Bearer ID value to be used for security protection of PDCP Control PDUs of one or more PDCP entities upon radio bearer configuration. The value may be introduced as a protocol extension.

BEARER parameter—PDCP PDU Approach 7: Use the ID of the logical channel, e.g., LCID, where the PDCP data may be mapped to as Bearer ID input parameter for protection of PDCP Control PDUs.

BEARER parameter—PDCP PDU Approach 8: Use the ID of the cell or cell group, where the PDCP data may be mapped to as Bearer ID input parameter for protection of PDCP Control PDUs. BEARER parameter—PDCP PDU Approach 9: All its bits set to 0). BEARER parameter—PDCP PDU Approach 10: All its bits set to 1.

BEARER parameter—PDCP PDU Approach 11: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

BEARER parameter—PDCP PDU Approach 12: The derivation of the Bearer ID value may be hidden to PDCP layer.

RLC control PDUs for e.g., the RLC status PDUs are security protected by using ciphering or integrity protection functions at the MAC layer. In other words, at the sender side, the PDCP entity that maps bearer data to a RLC entity may be used for ciphering or integrity protection of the RLC status PDUs generated by this RLC entity. The MAC entity processes the RLC status PDUs by using the following approaches for Bearer ID parameter selection.

BEARER parameter—RLC PDU Approach 1: Re-use the same Bearer ID derivation methods described for the case of security protection of PDCP control PDUs. In other words, for a PDCP control PDU generated by a given RLC entity, use the same Bearer ID input parameter as for the PDCP entity mapped to this RLC entity e.g., derive the Bearer ID input parameter in the same manner as for the protection of the PDCP control PDUs generated by the PDCP entity mapped to this RLC entity e.g., the PDCP entity whose SDUs are transferred via this RLC entity.—This approach may be a prime candidate approach for example for the scenarios where there is one-to-one mapping e.g., association between PDCP entity and RLC entity.

BEARER parameter—RLC PDU Approach 2: Re-use similar Bearer ID derivation methods described for the case of security protection of PDCP control PDUs. As for the bearer ID input parameter derivation is for a specific RLC entity contact, the Bearer ID input parameter may be same or may be different from the bearer ID input used for the security protection of PDCP control PDU generated by the PDCP entity associated with the RLC entity that generated the RLC control PDU. Several sub-approaches may be considered.

BEARER parameter—RLC PDU Approach 2-1: Use a fixed pre-defined default value as Bearer ID input parameter for RLC Control PDUs of one or more RLC entities. The fixed value may be captured in the specifications. More than one fixed pre-defined values may be defined.

BEARER parameter—RLC PDU Approach 2-2: Use a configurable value as Bearer ID input parameter for the security protection of RLC Control PDUs of one or more PDCP entities. RRC can explicitly configure a Bearer ID value to be used for security protection of RLC Control PDUs of one or more RLC entities during radio bearer configuration. The value may be introduced as a protocol extension. Several configurable values may be configured to the UE 102 as bearer ID input parameter for the security protection of RLC Control PDUs, with each value associated with one or more RLC entities. RRC may provide the configurable bearer ID input parameter to the UE 102 in RLC-BearerConfig-IE during radio bearer configuration.

BEARER parameter—RLC PDU Approach 2-3: Use the ID of a logical channel, e.g., the LCID associated with a RLC entity that generates a control PDU as Bearer ID input parameter for the security protection of the RLC Control PDU. For a given RLC entity. RRC provides LCID to the UE 102 during RLC configuration in RLC-BearerConfig IE, as part of radio bearer configuration.

BEARER parameter—RLC PDU Approach 2-4: Use the ID of a cell or a cell group, e.g., the cell or group of cells where a RLC entity that generates a RLC control PDU may be mapped to, as Bearer ID input parameter for protection of the RLC Control PDU. RRC provides each cell group in the UE 102, an ID during configuration of the cell group in CellGroupConfig IE. There are several possible alternatives for this approach.

For approach 2-4, the Cell Group ID parameter may be used as Bearer ID input parameter. If 5 bits input parameter is needed, use zero padding to provide 5 bits Bearer ID. The outcome of padding may be used as Bearer ID input parameter.

For approach 2-4, Bearer ID parameter may be obtained from concatenation of the Bearer ID that is configured to the RLC entity with Cell Group ID. If 5 bits input parameter is needed, use LSBs or MSBs of Bearer ID concatenated with Cell Group ID. The outcome of concatenation may be used as Bearer ID input parameter.

For approach 2-4, Bearer ID parameter may be obtained from concatenation of the LCID that is configured to the RLC entity with Cell Group ID. If 5 bits input parameter is needed, Bearer ID parameter may be obtained from concatenation of 3 LSB bits or 3 MSB bits of the LCID that is configured to the RLC entity with 2 bits Cell Group ID.

BEARER parameter—RLC PDU Approach 2-5: All its bits set to 0. BEARER parameter—RLC PDU Approach 2-6: All its bits set to 1.

BEARER parameter—RLC PDU Approach 2-7: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

BEARER parameter—RLC PDU Approach 3: The derivation of the Bearer ID value may be hidden to RLC layer.

The MAC entity security protects MAC CEs, PDCP Control PDUs, and RLC Control PDUs. The following approaches for Bearer ID input parameter selection are possible. The RLC entity processes the MAC CEs by using the following approaches for Bearer ID parameter selection.

BEARER parameter—MAC PDU Approach 1: Use the same Bearer ID input parameter for MAC CEs as may be used for the security protection of RLC and PDCP control PDUs. RRC provides a Bearer ID upon the configuration of the PDCP entity in the RadioBearerConfig Information Element (IE). The PDCP entity may use the bearer ID associated with the PDCP entity for which a PDCP control PDU is being generated as an input parameter to the security algorithms.

BEARER parameter—MAC PDU Approach 2: Use the LCID of the LCH where the MAC CEs are to be transferred as Bearer ID input parameter. RRC provides LCIDs upon MAC logical channel configuration in RLC-BearerConfig IE.

BEARER parameter—MAC PDU Approach 3: The Bearer ID input parameter may be derived from Cell Group IDs. RRC provides each cell group an ID upon configuration of the cell group in CellGroupConfig IE. There are several possible alternatives for this Approach 3.

BEARER parameter—MAC PDU Approach 3-1: The Cell Group ID parameter may be used as Bearer ID input parameter. If 5 bits input parameter is needed, use zero padding to provide 5 bits Bearer ID. The outcome of padding may be used as Bearer ID input parameter.

BEARER parameter—MAC PDU Approach 3-2: Bearer ID parameter may be obtained from concatenation of the Bearer ID that is configured to the MAC entity with Cell Group ID. If 5 bits input parameter is needed, use LSBs or MSBs of Bearer ID concatenated with Cell Group ID. The outcome of concatenation may be used as Bearer ID input parameter.

BEARER parameter—MAC PDU Approach 3-3: Bearer ID parameter may be obtained from concatenation of the LCID that is configured to the MAC entity with Cell Group ID. If 5 bits input parameter is needed, Bearer ID parameter may be obtained from concatenation of 3 LSB bits or 3 MSB bits of the LCID that is configured to the RLC entity with 2 bits Cell Group ID.

BEARER parameter—MAC PDU Approach 4: RRC configures explicitly a new MAC layer parameter to be used as Bearer ID input parameter for security protection. BEARER parameter—MAC PDU Approach 5: All its bits set to 0. BEARER parameter—MAC PDU Approach 6: All its bits set to 1.

BEARER parameter—MAC PDU Approach 7: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

Physical layer control information may be security protected by using ciphering or integrity protection functions at the MAC layer.

At the sender side, the PHY entity forwards control PDUs to the MAC entity for ciphering or integrity protection of the PHY control information. The MAC entity processes the PHY control information by using the following approaches for Bearer ID parameter selection.

BEARER parameter—PHY PDU Approach 1: Use the same Bearer ID input parameter for PHY control information as may be used for the security protection of MAC CEs, and RLC and PDCP control PDUs.

BEARER parameter—PHY PDU Approach 2: Use Radio Network Temporary Identifier (RNTI) value as Bearer ID input parameter. RRC provides RNTI values upon physical cell group configuration in PhysicalCellGroupConfig IE. If 5 bits input parameter is needed use MSB or LSB of RNTI value.

BEARER parameter—PHY PDU Approach 3: The Cell Group ID parameter may be used as Bearer ID input parameter. If 5 bits input parameter is needed, use zero padding to provide 5 bits Bearer ID. The outcome of padding may be used as Bearer ID input parameter.

BEARER parameter—PHY PDU Approach 4: Use a concatenation of Radio Network Temporary Identifier (RNTI) value with Cell Group ID. If 5 bits input parameter is needed, use MSB or LSB of RNTI value of RNTI concatenated with Cell Group ID: or Cell Group ID or concatenated with MSB or LSB of RNTI value of RNTI.

BEARER parameter—PHY PDU Approach 5: RRC configures explicitly a new PHY layer parameter to be used as Bearer ID input parameter for security protection. BEARER parameter—PHY PDU Approach 6: All its bits set to 0. BEARER parameter—PHY PDU Approach 7: All its bits set to 1.

If BEARER parameter—PHY PDU Approach 1 is not used, the PHY entity provides the Bearer ID parameter to the RLC entity for processing of the PHY control information. After processing, the MAC entity returns the data back to the PHY entity and the PHY layer may include the ciphered control information and the authentication codes to PHY PDUs.

At the receiving side, a reverse operation may be performed by sending the PHY control information to MAC and then back to PHY layer. The control information contents and ciphering units of PHY control PDUs may be sent to the MAC entity. The MAC entity may be used for computation of authentication codes and deciphering of data by using the LCID as input parameter. After processing, the RLC entity returns back to the MAC entity deciphered data and the output of the integrity protection algorithm whereof it is further transferred to the PHY layer.

The PDCP Control PDU may be submitted to the RLC layer and further passed to MAC layer where the MAC COUNT value is used as an input to security protection algorithms. The derivation and maintenance of the MAC COUNT value may be hidden to PDCP layer.

The RLC Control PDU may be submitted to the MAC layer where the MAC COUNT value is used as an input to security protection algorithms. The derivation and maintenance of the MAC COUNT value may be hidden to RLC layer.

MAC PDU may be appended with a 32 bits SN to be used as COUNT input parameter for security protection algorithms. The following approaches are possible.

COUNT parameter-MAC PDU Approach 1: MAC PDU specific COUNT may be derived from MAC SN where the same SN is used as COUNT input parameter to MAC CEs within the same MAC PDU.

COUNT parameter-MAC PDU Approach 2: MAC subPDU specific COUNT may be derived from MAC subPDU specific SN which is used as COUNT input parameter to such MAC CEs that are used for the same LCH.

### PHY Control PDU or Signal Protection

PHY PDU may be appended with a 32 bits SN to be used as COUNT input parameter for security protection algorithms. Transport Block (TB) specific COUNT may be derived from PHY SN where the same SN is used as COUNT input parameter to control information within the same TB. The following approaches are possible.

COUNT parameter-PHY PDU Approach 1: PHY PDU specific COUNT may be derived from PHY SN where the same SN is used as COUNT input parameter to control information within the same TB.

COUNT parameter-PHY PDU Approach 2: PHY PDU specific COUNT may be derived from PHY SN where the same SN is used as COUNT input parameter to control information within the same physical layer frame.

The PHY COUNT value may be provided to MAC layer when PHY control information is sent to MAC for ciphering, deciphering, or integrity protection.

Message parameter. In order to provide PDCP Control PDU content to the MAC via RLC layer, the RLC layer needs to know which one of the submitted PDUs are control PDUs that are subject to security protection on the MAC layer. There are several approaches to pass this kind of information to RLC layer.

MESSAGE parameter-PDCP PDU Approach 1: The PDCP Service Data (SDU) submitted to RLC layer contains a protocol discriminator field. The discriminator field may carry a bit that indicates whether the PDCP SDU is a Control PDU or not.

MESSAGE parameter-PDCP PDU Approach 2: The RLC layer provides a secure data transfer Service Access Point (SAP) towards PDCP layer. Only PDCP Control PDUs may be submitted to RLC layer via the secure SAP.

MESSAGE parameter-PDCP PDU Approach 3: All bearers may be configured with at least two RLC entities where one of the entities are intended to be used for the transfer of PDCP Control PDUs in a secure manner.

The RLC layer passes PDCP Control PDUs further to MAC layer for security protection. The details of how PDCP Control PDUs traverse through RLC entities to MAC may be hidden to PDCP layer.

In order to submit RLC Control PDU content and pass PDCP Control PDU content to the MAC for security protection, the MAC layer needs to know which one of the submitted SDUs contain control information that is subject to security protection on the MAC layer. There are several approaches to pass this kind of information to MAC layer.

MESSAGE parameter-RLC PDU Approach 1: The RLC Service Data (SDU) submitted to RLC layer contains a protocol discriminator field. The discriminator field may carry a bit that indicates whether the RLC SDU contains control information or not.

MESSAGE parameter-RLC PDU Approach 2: The MAC layer provides a secure LCH towards RLC layer. Only L2 control information may be submitted to MAC layer via the secure LCH.

MESSAGE parameter-RLC PDU Approach 3: A separate MAC entity may be configured only for the transfer of L2 control information in a secure manner.

The RLC layer may pass L2 control information to MAC layer for security protection.

The content of the MAC CE and submitted L2 control information from upper layer may be provided as an input to the integrity protection algorithm. After the computation of authentication code, the MAC entity adds the authentication code to the MAC PDU. The following approaches are possible to address MAC PDU or MAC subPDU integrity.

MESSAGE parameter-MAC PDU Approach 1: MAC PDU specific authentication code may be derived by using a concatenation of MAC CEs with L2 control information that are to be transferred with the same MAC PDU as an input to the integrity protection algorithm. The authentication code may be computed by the MAC layer and added in the same MAC PDU where the MAC CEs and L2 control information are transferred. The MAC PDU format conveys an authentication code.

MESSAGE parameter-MAC PDU Approach 2: MAC subPDU specific authentication code may be derived by using a concatenation of such MAC CEs with L2 control information that are to be transferred within the same MAC subPDU as an input to the integrity protection algorithm. The authentication code may be computed by the MAC entity and added in the MAC subPDU where the MAC CEs and L2 control information are transferred. The MAC subPDU format conveys an authentication code.

The content of the PHY Control information may be provided as an input to the integrity protection algorithm. The content may be sent to MAC entity and the MAC entity computes an authentication code. After the computation, the code may be sent from the MAC entity to the PHY entity. The PHY entity adds the authentication code to the PHY Control PDU which may be any PHY layer data unit. The following approaches are possible to address TB or frame-level integrity.

MESSAGE parameter-PHY PDU Approach 1: TB specific authentication code may be derived by using a concatenation of control information that is to be transferred with the same TB as an input to the integrity protection algorithm. The authentication code may be computed by the MAC layer and added in the same TB where the control information is transferred. The TB format conveys an authentication code.

MESSAGE parameter-PHY PDU Approach 2: Frame specific authentication code may be derived by using a concatenation of control information that is to be transferred within the same frame as an input to the integrity protection algorithm. The authentication code may be computed by the MAC layer and added in the frame where the control information is transferred. The frame structure and format convey an authentication code.

### Security Functions in PHY

The following approaches for security protection input parameter selection and derivation may be based on the assumption that security functions for control information protection reside in PHY layer.

The PDCP Control PDUs may be ciphered or integrity protected by using the Bearer ID as an input parameter to security algorithms. The following approaches are possible for the Bearer ID parameter selection.

BEARER parameter—PDCP PDU Approach 1: RRC provides a Bearer ID upon the configuration of the PDCP entity in the RadioBearerConfig Information Element (IE). The PHY entity uses the bearer ID associated with the PDCP entity for which a PDCP control PDU is being generated as an input parameter to the security algorithms.

BEARER parameter—PDCP PDU Approach 2: A default bearer ID may be used as an input parameter for a PDCP control PDU protection. RRC provides information about a default bearer ID upon radio bearer configuration.

For Approach 2, if the core network (CN) association is with 4G Evolved Packet System (EPS), the corresponding EPS bearer ID may be provided to configured DRBs in the instances of DRB-ToAddModList. The DRB instance that is configured with the EPS default bearer value, as provided by the NAS protocol, is the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

For Approach 2, if the CN association is with 5G Core network (5GC), the default bearer information is indicated in the DRB-ToAddModList. The DRB instance that is the default bearer conveys an indicator in the SDAP-Config IE where the field defaultDRB is set to value TRUE for the default bearer. The Bearer ID of the default bearer may be used as Bearer ID input parameter for PDCP Control PDU protection in one or more PDCP entities. More than one default bearer ID may be configured into the UE 102 for the purpose of security protection of control PDUs. For example, one default bearer ID may be configured to the UE 102 and used by the UE 102 as Bearer ID input for security protection of PDCP control PDUs generated by PDCP entities associated with SRBs and another default bearer ID may be configured to the UE 102 and used by the UE 102 for security protection of PDCP control PDUs generated by PDCP entities associated with DRBs. In yet another example, one default bearer ID may be configured to the UE 102 and used by the UE 102 as Bearer ID input parameter for protection of PDCP control PDUs.

BEARER parameter—PDCP PDU Approach 3: Use SRB1 ID for PDCP control PDUs. RRC configures SRB1 ID value upon radio bearer configuration. RRC configures SRB1 ID value upon radio bearer configuration.

BEARER parameter—PDCP PDU Approach 4: Use SRB1 ID for PDCP control PDUs except for SRB2 PDCP related control PDU where SRB2 ID may be used. RRC configures both SRB1 and SRB2 ID values upon radio bearer configuration.

BEARER parameter—PDCP PDU Approach 5: Use a fixed pre-defined default value as Bearer ID input parameter for PDCP Control PDUs of one or more PDCP entities. The fixed value may be captured in the specifications. More than one fixed pre-defined values may be defined.

BEARER parameter—PDCP PDU Approach 6: Use a configurable value as Bearer ID input parameter for PDCP Control PDUs of one or more PDCP entities. RRC can explicitly configure a Bearer ID value to be used for security protection of PDCP Control PDUs of one or more PDCP entities upon radio bearer configuration. The value may be introduced as a protocol extension.

BEARER parameter—PDCP PDU Approach 7: Use the ID of the logical channel, e.g., LCID, where the PDCP data may be mapped to as Bearer ID input parameter for protection of PDCP Control PDUs.

BEARER parameter—PDCP PDU Approach 8: Use the ID of the cell or cell group, where the PDCP data may be mapped to as Bearer ID input parameter for protection of PDCP Control PDUs. BEARER parameter—PDCP PDU Approach 9: All its bits set to 0. BEARER parameter—PDCP PDU Approach 10: All its bits set to 1.

BEARER parameter—PDCP PDU Approach 11: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

The RLC Control PDU may be submitted to the MAC layer. The derivation of the Bearer ID value may be hidden to RLC layer.

The MAC Control PDU may be submitted to the PHY layer. The derivation of the Bearer ID value may be hidden to MAC layer. The following approaches are possible for Bearer ID selection.

BEARER parameter—PHY PDU Approach 1: Use the same Bearer ID input parameter for PHY control information as may be used for the security protection of MAC CEs, and RLC and PDCP control PDUs.

BEARER parameter—PHY PDU Approach 2: Use Radio Network Temporary Identifier (RNTI) value as Bearer ID input parameter. RRC provides RNTI values upon physical cell group configuration in PhysicalCellGroupConfig IE. If 5 bits input parameter is needed use MSB or LSB of RNTI value.

BEARER parameter—PHY PDU Approach 3: The Cell Group ID parameter may be used as Bearer ID input parameter. If 5 bits input parameter is needed, use zero padding to provide 5 bits Bearer ID. The outcome of padding may be used as Bearer ID input parameter.

BEARER parameter—PHY PDU Approach 4: Use a concatenation of Radio Network Temporary Identifier (RNTI) value with Cell Group ID. If 5 bits input parameter is needed, use MSB or LSB of RNTI value of RNTI concatenated with Cell Group ID: or Cell Group ID or concatenated with MSB or LSB of RNTI value of RNTI.

BEARER parameter—PHY PDU Approach 5: RRC configures explicitly a new PHY layer parameter to be used as Bearer ID input parameter for security protection. BEARER parameter—PHY PDU Approach 6: All its bits set to 0. BEARER parameter—PHY PDU Approach 7: All its bits set to 1.

BEARER parameter—PHY PDU Approach 8: Use Transmission and Reception Point (TRP) ID as Bearer ID input parameter for protection of PDCP Control PDUs. See 3GPP TS 38.213 NR and 3GPP TS 38.214 NR.

BEARER parameter—PHY PDU Approach 9: Use Component Carrier (CC) ID as Bearer ID input parameter for protection of PDCP Control PDUs. See 3GPP TS 38.213 NR and 3GPP TS 38.214 NR.

BEARER parameter—PHY PDU Approach 10: Use beam ID or beam group ID as Bearer ID input parameter for protection of PDCP Control PDUs. See 3GPP TS 38.213 NR and 3GPP TS 38.214 NR.

BEARER parameter—PHY PDU Approach 11: Use Multiple Input Multiple Output (MIMO ID or beam group ID as Bearer ID input parameter for protection of PDCP Control PDUs. See 3GPP TS 38.213 NR and 3GPP TS 38.214 NR.

BEARER parameter—PHY PDU Approach 12: Use SL source L1 ID as Bearer ID input parameter for protection of PDCP Control PDUs. See 3GPP TS 38.213 NR and 3GPP TS 38.214 NR.

BEARER parameter—PHY PDU Approach 13: Use SL destination L1 ID as Bearer ID input parameter for protection of PDCP Control PDUs. See 3GPP TS 38.213 NR and 3GPP TS 38.214 NR.

The PDCP Control PDU may be submitted to the RLC layer. The derivation of the COUNT value may be hidden to PDCP layer.

The RLC Control PDU may be submitted to the RLC layer. The derivation of the COUNT value may be hidden to RLC layer.

The MAC Control PDU may be submitted to the PHY layer. The derivation of the COUNT value may be hidden to MAC layer.

PHY PDU may be appended with a 32 bits SN to be used as COUNT input parameter for security protection algorithms. Transport Block (TB) specific COUNT may be derived from PHY SN where the same SN is used as COUNT input parameter to control information within the same TB. The following approaches are possible.

COUNT parameter-PHY PDU Approach 1: PHY PDU specific COUNT may be derived from PHY SN where the same SN is used as COUNT input parameter to control information within the same TB.

COUNT parameter-PHY PDU Approach 2: PHY PDU specific COUNT may be derived from PHY SN where the same SN is used as COUNT input parameter to control information within the same physical layer frame.

In order to provide PDCP Control PDU content to the PHY via RLC/MAC layer, the RLC layer needs to know which one of the submitted PDUs may be control PDUs that are subject to security protection on the PHY layer. There are several approaches to pass this kind of information to RLC layer.

MESSAGE parameter-PDCP PDU Approach 1: The PDCP Service Data (SDU) submitted to RLC layer contains a protocol discriminator field. The discriminator field may carry a bit that indicates whether the PDCP SDU is a Control PDU or not.

MESSAGE parameter-PDCP PDU Approach 2: The RLC layer provides a secure data transfer Service Access Point (SAP) towards PDCP layer. Only PDCP Control PDUs may be submitted to RLC layer via the secure SAP.

MESSAGE parameter-PDCP PDU Approach 3: All bearers may be configured with at least two RLC entities where one of the entities are intended to be used only for the transfer of PDCP Control PDUs in a secure manner.

The RLC layer passes PDCP Control PDUs further to MAC layer. The details of how PDCP Control PDUs traverse through RLC entities to MAC may be hidden to PDCP layer.

In order to submit RLC Control PDU contents and pass PDCP Control PDU content to the MAC, the MAC layer needs to know which one of the submitted SDUs contain control information that is subject to security protection on the MAC layer. There are several approaches to pass this kind of information to MAC layer.

MESSAGE parameter-RLC PDU Approach 1: The RLC Service Data (SDU) submitted to MAC layer contains a protocol discriminator field. The discriminator field may carry a bit that indicates whether the RLC SDU contains control information or not.

MESSAGE parameter-RLC PDU Approach 2: The MAC layer provides a secure LCH towards RLC layer. Only L2 control information may be submitted to MAC layer via the secure LCH. MESSAGE parameter-RLC PDU Approach 3: A separate MAC entity may be configured for the transfer of L2 control information in a secure manner.

The RLC layer may pass L2 control information to MAC layer.

The content of MAC CEs and submitted L2 control information from upper layer may be provided as an input to the integrity protection algorithm on PHY layer. The PHY layer may need to know which one of the submitted data units are subject for integrity protection. There are several approaches to pass this kind of information to PHY layer. MESSAGE parameter-MAC PDU Approach 1: The MAC Service Data (SDU) submitted to MAC layer contains a protocol discriminator field. The discriminator field may carry a bit that indicates whether the MAC SDU contains control information or not. MESSAGE parameter-MAC PDU Approach 2: The PHY layer provides a secure transport channel towards MAC layer. Only L2 control information may be submitted to PHY layer via the secure transport channel.

MESSAGE parameter-MAC PDU Approach 3: A separate PHY entity may be configured only for the transfer of L2 control information in a secure manner. The content of the PHY Control information may be provided as an input to the integrity protection algorithm. The PHY entity computes an authentication code and adds the code to PHY Control PDU which may be any PHY layer data unit. The following approaches are possible to address TB or frame-level integrity.

MESSAGE parameter-PHY PDU Approach 1: TB specific authentication code may be derived by using a concatenation of control information that is to be transferred with the same TB as an input to the integrity protection algorithm. The authentication code may be computed by the MAC layer and added in the same TB where the control information is transferred. The TB format conveys an authentication code.

MESSAGE parameter-PHY PDU Approach 2: Frame specific authentication code may be derived by using a concatenation of control information that is to be transferred within the same frame as an input to the integrity protection algorithm. The authentication code may be computed by the MAC layer and added in the frame where the control information is transferred. The frame structure and format convey an authentication code.

MESSAGE parameter-PHY PDU Approach 3: Transmission Time Interval (TTI) specific authentication code may be derived by using a concatenation of control information that is to be transferred within the same TTI as an input to the integrity protection algorithm. The authentication code may be computed by the MAC layer and added in the frame where the control information is transferred. The frame structure and format convey an authentication code.

MESSAGE parameter-PHY PDU Approach 4: Subframe specific authentication code may be derived by using a concatenation of control information that is to be transferred within the same subframe as an input to the integrity protection algorithm. The authentication code may be computed by the MAC layer and added in the frame where the control information is transferred. The frame structure and format convey an authentication code.

MESSAGE parameter-PHY PDU Approach 5: A slot specific authentication code may be derived by using a concatenation of control information that is to be transferred within the same slot as an input to the integrity protection algorithm. The authentication code may be computed by the MAC layer and added in the frame where the control information is transferred. The frame structure and format convey an authentication code.

Security Functions in SDAP. The SDAP Control PDUs may be ciphered or integrity protected by using the Bearer ID as an input parameter to security algorithms. The following approaches are possible for the Bearer ID parameter selection.

BEARER parameter—SDAP PDU Approach 1: A Quality of Service (QOS) flow ID may be used as an input parameter for a SDAP control PDU protection. RRC provides information about QoS flow IDs upon SDAP configuration.

BEARER parameter—SDAP PDU Approach 2: A PDU Session ID may be used as an input parameter for a SDAP control PDU protection. RRC provides information about PDU session IDs upon SDAP configuration.

BEARER parameter—SDAP PDU Approach 3: RRC provides a Bearer ID upon the configuration of the SDAP entity in the SDAP-Config Information Element (IE). The SDAP entity uses the bearer ID associated with the PDCP entity for which a PDCP control PDU is being generated as an input parameter to the security algorithms.

BEARER parameter—SDAP PDU Approach 4: A default bearer ID may be used as an input parameter for a SDAP control PDU protection. RRC provides information about a default bearer ID upon radio bearer configuration.

For the Approach 4, if the core network (CN) association is with 4G Evolved Packet System (EPS), the corresponding EPS bearer ID may be provided to configured DRBs in the instances of DRB-ToAddModList. The DRB instance that is configured with the EPS default bearer value, as provided by the NAS protocol, is the default bearer. The Bearer ID of the default bearer may be used as Bearer ID input parameter for SDAP Control PDU protection in one or more SDAP entities. More than one default bearer ID may be configured into the UE 102 for the purpose of security protection of control PDUs. For example, one default bearer ID may be configured to the UE 102 and used by the UE 102 as Bearer ID input for security protection of SDAP control PDUs generated by SDAP entities associated with SRBs and another default bearer ID may be configured to the UE 102 and used by the UE 102 for security protection of SDAP control PDUs generated by SDAP entities associated with DRBs. In yet another example, one default bearer ID may be configured to the UE 102 and used by the UE 102 as Bearer ID input parameter for protection of SDAP control PDUs.

For the Approach 4, if the CN association is with 5G Core network (5GC), the default bearer information is indicated in the DRB-ToAddModList. The DRB instance that is the default bearer conveys an indicator in the SDAP-Config IE where the field defaultDRB is set to value TRUE for the default bearer. The Bearer ID of the default bearer may be used as Bearer ID input parameter for SDAP Control PDU protection in one or more SDAP entities. More than one default bearer ID may be configured into the UE 102 for the purpose of security protection of control PDUs. For example, one default bearer ID may be configured to the UE 102 and used by the UE 102 as Bearer ID input for security protection of SDAP control PDUs generated by SDAP entities associated with SRBs and another default bearer ID may be configured to the UE 102 and used by the UE 102 for security protection of SDAP control PDUs generated by SDAP entities associated with DRBs. In yet another example, one default bearer ID may be configured to the UE 102 and used by the UE 102 as Bearer ID input parameter for protection of SDAP control PDUs.

BEARER parameter—SDAP PDU Approach 5: Use SRB1 ID for SDAP control PDUs. RRC configures SRB1 ID value upon radio bearer configuration. RRC configures SRB1 ID value upon radio bearer configuration.

BEARER parameter—SDAP PDU Approach 6: Use SRB1 ID for PDCP control PDUs except for SRB2 SDAP related control PDU where SRB2 ID is used. RRC configures both SRB1 and SRB2 ID values upon radio bearer configuration.

BEARER parameter—SDAP PDU Approach 7: Use a fixed pre-defined default value as Bearer ID input parameter for SDAP Control PDUs of one or more SDAP entities. The fixed value may be captured in the specifications. More than one fixed pre-defined values may be defined.

BEARER parameter—SDAP PDU Approach 8: Use a configurable value as Bearer ID input parameter for SDAP Control PDUs of one or more SDAP entities. RRC can explicitly configure a Bearer ID value to be used for security protection of SDAP Control PDUs of one or more SDAP entities upon radio bearer configuration. The value may be introduced as a protocol extension.

BEARER parameter—SDAP PDU Approach 9: Use the ID of the logical channel, e.g., LCID, where the SDAP data may be mapped to as Bearer ID input parameter for protection of SDAP Control PDUs.

BEARER parameter—SDAP PDU Approach 10: Use the ID of the cell or cell group, where the SDAP data may be mapped to as Bearer ID input parameter for protection of SDAP Control PDUs. BEARER parameter—SDAP PDU Approach 11: All its bits set to 0). BEARER parameter—SDAP PDU Approach 12: All its bits set to 1.

BEARER parameter—SDAP PDU Approach 13: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

SDAP PDU may be appended with a 32 bits SN to be used as COUNT input parameter for security protection algorithms.

The content of the SDAP Control PDU is used as message input parameter for security protection algorithms.

Security Functions in BAP. The BAP Control PDUs may be ciphered or integrity protected by using the Bearer ID as an input parameter to security algorithms. See 3GPP TS 38.340 NR. The following approaches are possible for the Bearer ID parameter selection.

BAP Control PDU Approach 1: A Backhaul (BH) RLC ID may be used as an input parameter for a BAP control PDU protection. RRC provides information about BH RLC IDs upon BAP configuration.

BAP Control PDU Approach 2: A BAP routing ID may be used as an input parameter for a BAP control PDU protection. RRC provides information about BAP Routing IDs upon BAP configuration.

BAP Control PDU Approach 3: RRC provides a Bearer ID upon the configuration of the BAP entity in the BAP-Config Information Element (IE). The BAP entity uses the bearer ID associated with the BAP entity for which a BAP control PDU is being generated as an input parameter to the security algorithms.

BAP Control PDU Approach 4: A default bearer ID may be used as an input parameter for a BAP control PDU protection. RRC provides information about a default bearer ID upon radio bearer configuration.

For approach 4, if the core network (CN) association is with 4G Evolved Packet System (EPS), the corresponding EPS bearer ID may be provided to configured DRBs in the instances of DRB-ToAddModList. The DRB instance that is configured with the EPS default bearer value, as provided by the NAS protocol, may be the default bearer. The Bearer ID of the default bearer may be used as Bearer ID input parameter for BAP Control PDU protection in one or more BAP entities. More than one default bearer ID may be configured into the UE 102 for the purpose of security protection of control PDUs. For example, one default bearer ID may be configured to the UE 102 and used by the UE 102 as Bearer ID input for security protection of BAP control PDUs generated by SDAP entities associated with SRBs and another default bearer ID may be configured to the UE 102 and used by the UE 102 for security protection of BAP control PDUs generated by BAP entities associated with DRBs. In yet another example, one default bearer ID may be configured to the UE 102 and used by the UE 102 as Bearer ID input parameter for protection of BAP control PDUs.

For approach 4, if the CN association may be with 5G Core network (5GC), the default bearer information may be indicated in the DRB-ToAddModList. The DRB instance that may be the default bearer conveys an indicator in the RRC configuration where the field defaultDRB may be set to value TRUE for the default bearer. The Bearer ID of the default bearer may be used as Bearer ID input parameter for BAP Control PDU protection in one or more BAP entities. More than one default bearer ID may be configured into the UE 102 for the purpose of security protection of control PDUs. For example, one default bearer ID may be configured to the UE 102 and used by the UE 102 as Bearer ID input for security protection of BAP control PDUs generated by BAP entities associated with SRBs and another default bearer ID may be configured to the UE 102 and used by the UE 102 for security protection of BAP control PDUs generated by BAP entities associated with DRBs. In yet another example, one default bearer ID may be configured to the UE 102 and used by the UE 102 as Bearer ID input parameter for protection of BAP control PDUs.

BAP Control PDU Approach 5: Use SRB1 ID for BAP control PDUs. RRC configures SRB1 ID value upon radio bearer configuration. RRC configures SRB1 ID value upon radio bearer configuration.

BAP Control PDU Approach 6: Use SRB1 ID for BAP control PDUs except for SRB2 BAP related control PDU where SRB2 ID is used. RRC configures both SRB1 and SRB2 ID values upon radio bearer configuration.

BAP Control PDU Approach 7: Use a fixed pre-defined default value as Bearer ID input parameter for BAP Control PDUs of one or more BAP entities. The fixed value may be captured in the specifications. More than one fixed pre-defined values may be defined.

BAP Control PDU Approach 8: Use a configurable value as Bearer ID input parameter for BAP Control PDUs of one or more BAP entities. RRC can explicitly configure a Bearer ID value to be used for security protection of BAP Control PDUs of one or more BAP entities upon radio bearer configuration. The value may be introduced as a protocol extension.

BAP Control PDU Approach 9: Use the ID of the logical channel, i.e. LCID, where the BAP data may be mapped to as Bearer ID input parameter for protection of BAP Control PDUs.

BAP Control PDU Approach 10: Use the ID of the cell or cell group, where the BAP data may be mapped to as Bearer ID input parameter for protection of BAP Control PDUs. BAP Control PDU Approach 11: All its bits set to 0. BAP Control PDU Approach 12: All its bits set to 1.

BAP Control PDU Approach 13: A combination of two or more of the approaches described herein. For example, the Bearer ID input parameter may be bearer ID and logical channel ID, bearer ID and cell ID or cell group ID, logical channel ID and cell ID or cell group ID, or bearer ID, logical channel ID and cell ID or cell group ID.

BAP PDU may be appended with a 32 bits SN to be used as COUNT input parameter for security protection algorithms.

The content of the BAP Control PDU may be used as message input parameter for security protection algorithms.

The introduction of new security functions and parameters also calls for new capabilities because new features and functionalities are normally optional. See 3GPP TS 38.331 and 3GPP TS 38.306 NR. The following capabilities may be needed to indicate the support of the above described functionalities.

The UE 102 may indicate support of integrity protection of PDCP Control PDUs which may mean that the UE 102 may be capable to comprehend PDCP Control PDU formats that include authentication codes. The UE 102 may be capable to generate PDCP Control PDUs with authentication codes and verify the authenticity of PDCP Control PDUs from the authentication code.

The UE 102 may indicate support of confidentiality protection of PDCP Control PDUs which means that the UE 102 may be capable to cipher and decipher PDCP Control PDUs.

The UE 102 may indicate support of integrity protected RLC Control PDUs which means that the UE 102 may be capable to comprehend RLC Control PDU formats that include authentication codes. The UE 102 may be capable to generate RLC Control PDUs with authentication codes and verify the authenticity of RLC Control PDUs from the authentication code.

The UE 102 may indicate support of confidentiality protection of RLC Control PDUs which means that the UE 102 may be capable to cipher and decipher RLC Control PDUs.

The UE 102 may indicate support of integrity protected MAC Control PDUs which means that the UE 102 may be capable to comprehend MAC Control PDU formats that include authentication codes. The UE 102 may be capable to generate MAC Control PDUs with authentication codes and verify the authenticity of MAC Control PDUs from the authentication code.

The UE 102 may indicate support of confidentiality protection of MAC Control PDUs which means that the UE 102 may be capable to cipher and decipher MAC Control PDUs.

The UE 102 may indicate support of integrity protected PHY Control PDUs which means that the UE 102 may be capable to comprehend PHY Control PDU formats that include authentication codes. The UE 102 may be capable to generate PHY Control PDUs with authentication codes and verify the authenticity of PHY Control PDUs from the authentication code.

The UE 102 may indicate support of confidentiality protection of PHY Control PDUs which means that the UE 102 may be capable to cipher and decipher RLC Control PDUs.

The capabilities may be dynamically associated with security functions. For example, depending on trigger, environment, location, or RAT.

Approach to issue 2: How to improve system performance by moving signaling from L3 to secure L2/L1?

Activation and deactivation of radio interface features may be associated with bit combinations instead of individual bits like in 3GPP LTE/NR MAC Control Elements. Features and features sets may be associated with unique bit combinations by using n bits and 2ⁿ possible bit combinations. Bit combinations can also be associated with one or several features, feature sets, configurations and possibly combinations thereof. Herein, they may be referred to as features, for the sake of simplicity.

An example of mapping from 7-bit combinations to features is shown in Table 2 below where bit combinations may be mapped to corresponding semantics or meaning.

TABLE 2

| Identifier | Semantics |
|---|---|
| 0000001 | Feature 1 |
| 0000010 | Feature 2 |
| 0000011 | Feature 1 + 2 |
| 0000100 | Feature 3 |
| 0000101 | Feature 1 + 2 + 3 |
| . . . | |
| 1111111 | Features 1 . . . n |

A bit combination may be sent to activate or deactivate a feature as defined in the semantics Table 2. The receiving side's behavior upon the reception of the bit combination may be as follows.

Approach 1: To toggle the status(es) of feature(s) between activated and deactivated status. If a feature is activated, reception of a bit combination that is associated with the feature results into deactivation of the feature. If a feature is deactivated, reception of a bit combination that is associated with the feature results into activation of the feature.

Approach 2: Instead of toggling the status(es), a separate bit may be transferred and associated with a bit combination to explicitly indicate the status of configured features. The bit may be embedded into a protocol field in radio interface control information such as protocol control elements, control indications, data unit headers, and as part of control messages or status reports. The meaning of the separate bit may be as follows: 1 means activation and 0 means deactivation, or 0 means activation and 1 means deactivation.

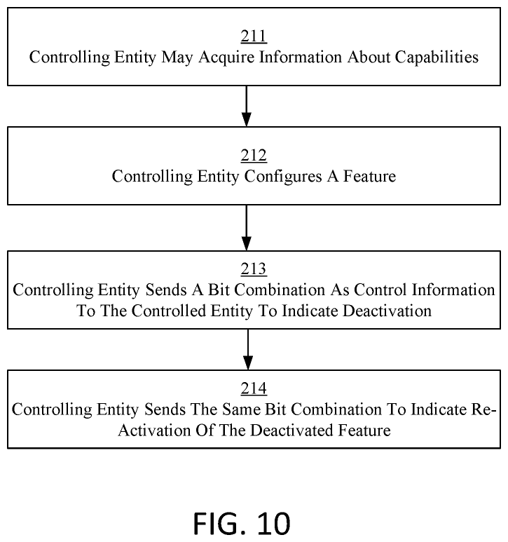

A controlling entity, such as a network node, uses bit combinations and control information formats that are comprehended by the controlled entity, such as a UE. FIG. 10 illustrates an exemplary flow for configuration, subsequent deactivation, or activation.

At step 211, the controlling entity may acquire information about capabilities or supported features of the controlled entity.

At step 212, the controlling entity may configure a feature, and the configuration may be associated with a bit combination to be used for subsequent deactivation or re-activation of the configured feature.

At step 213, upon deactivation of the feature, the controlling entity may send a bit combination as control information to the controlled entity to indicate deactivation. The bit combination may also be accompanied with an explicit indication of the feature status.

At step 214, upon re-activation, the controlling entity may send the same bit combination to indicate re-activation of the deactivated feature. The re-activation may also convey explicit indication of the feature status.

The bit combination may be embedded as a protocol field into radio interface control information such as in protocol control elements, control indications, data unit headers, and as part of control messages or status reports.

Indication on PDCP Layer—The bit combination field may be included in a PDCP PDU or PDCP Control PDU as control information.

Indication on RLC Layer—The bit combination field may be included in a RLC PDU or RLC Control PDU as control information.

Indication on MAC Layer—The bit combination field may be included in a MAC PDU as Control Element (CE) in the PDU or subPDU header or as separate control PDU or subPDU.

Indication on PHY Layer—The bit combination field may be included in PHY Downlink Control Information (DCI).

Approach to issue 3: How to handle system information overhead problems caused by digital signatures?

A controlled entity, such as UE, may receive broadcasted system information from a controlling entity, such as a radio network node. The controlling entity may schedule transmission of system information by transferring one or several system information blocks in a system information message over the air.

The broadcasted system information message may be security protected by adding authentication codes in the transferred data. The following approaches are possible.

Approach 1: An authentication code may be computed and appended to transferred system information blocks prior transmission. The receiving side computes authentication codes to received blocks and verifies the integrity of individual blocks. Upon detection of failed integrity check the receiving side may proceed as follows, such as: Discard such blocks where integrity check fails but maintain the rest of the blocks: Discard such blocks that were transferred in the same system information message where the integrity check fails in anyone of the block but maintain the rest of the system information messages: Discard system information broadcasted by the network node: or Add the network node to an excluded list, start a timer, and when the timer expires remove the node from the excluded list and reacquire system information from the network node again.

Approach 2: An authentication code is appended in the system information message that conveys multiple system information blocks over the air. The receiving side computes authentication codes to the system information message verifies its integrity. Upon detection of failed integrity check the receiving side may proceed as follow, such as: Discard such messages where the integrity check fails but maintain the rest of the messages: Discard system information broadcasted by the network node: or add the network node to an excluded list, start a timer, and when the timer expires remove the node from the excluded list and reacquire system information from the network node again.

The controlling entity may choose which one of the data units are integrity protected and thereby control the amount of overhead caused by authentication codes.

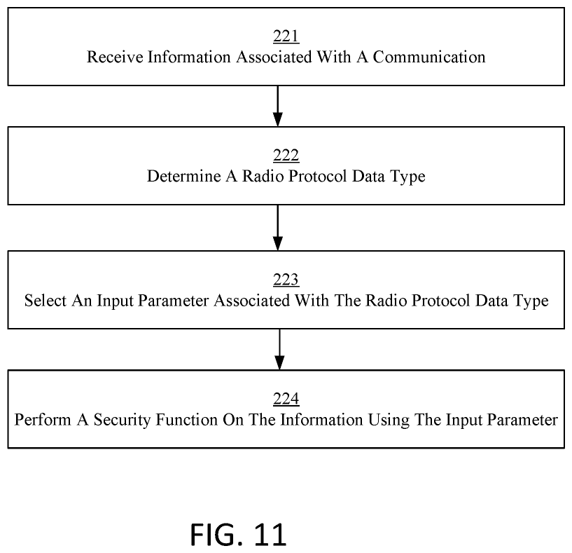

FIG. 11 illustrates an exemplary method for performing security protection functions (also referred herein as security function). At step 221, receiving information associated with a communication. The communication may be a wireless communication that may be transmitted to or from UE 102.

At step 222, determining a radio protocol data type, which may be from a list of a plurality of radio protocol data types, associated with the information transmitted in the communication. The radio protocol data type may be control protocol data unit (PDU), header of control PDU, header of data PDU, or radio resource control (RRC) message using common control channel (CCCH). See Table 1 which provides example information or affiliated layer that may be a trigger for selecting input parameters as described in step 223.

At step 223, based on the radio protocol data type or other triggers (e.g., thresholds associated with the received information), selecting, for performing a security function on the information, one or more input parameters associated with the radio protocol data type. The input parameters disclosed herein may include parameters such as bearer parameter, count parameter, or message parameter.

At step 224, performing the security function on the information using the one or more input parameters specific to the radio protocol data type. The security function may include a ciphering protection function or an integrity protection function.

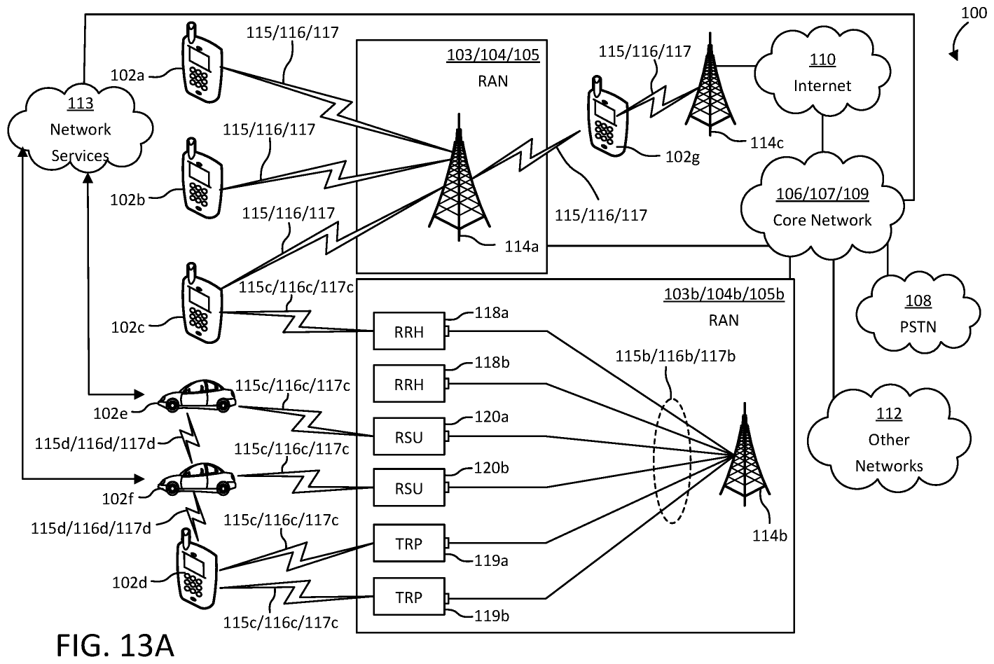

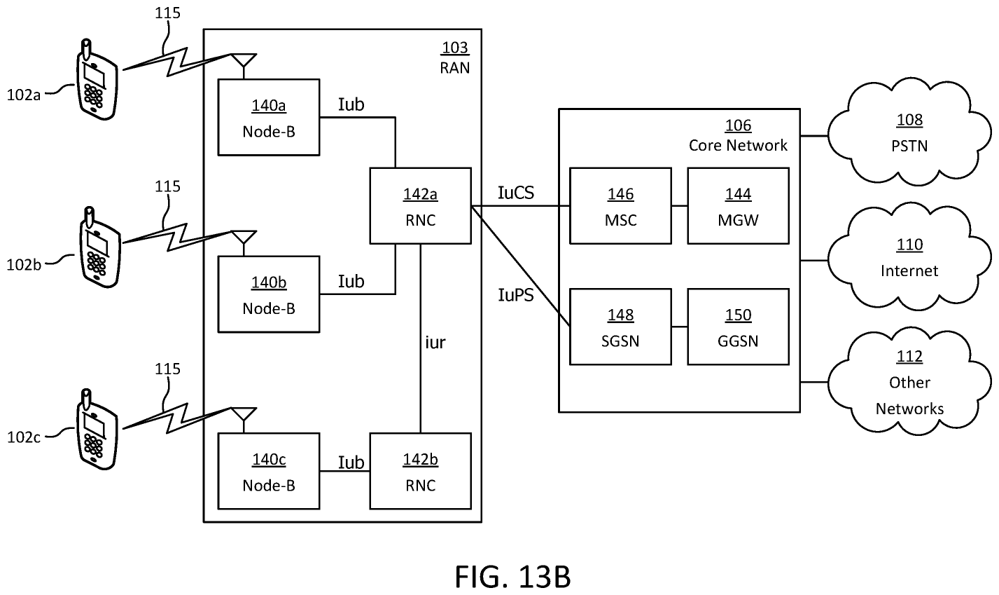

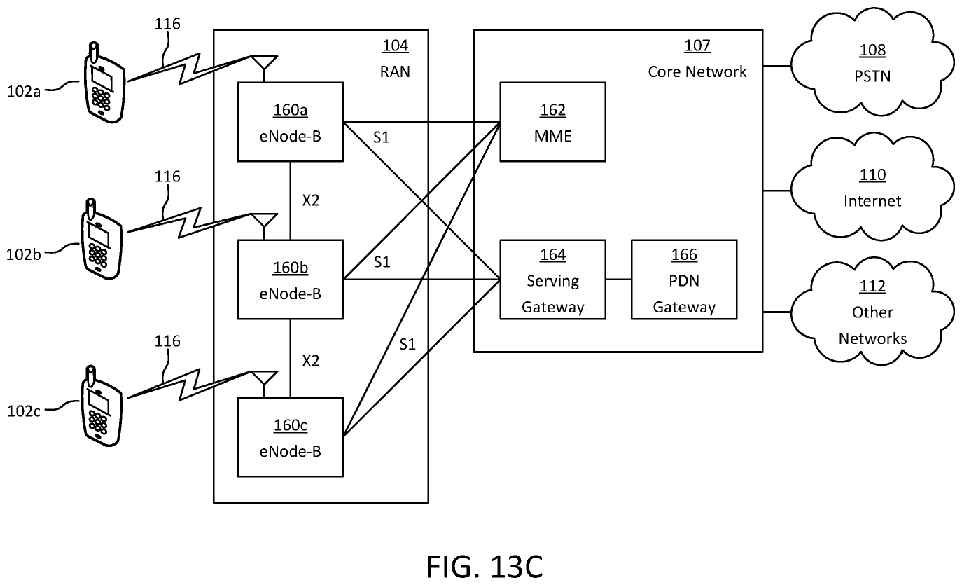

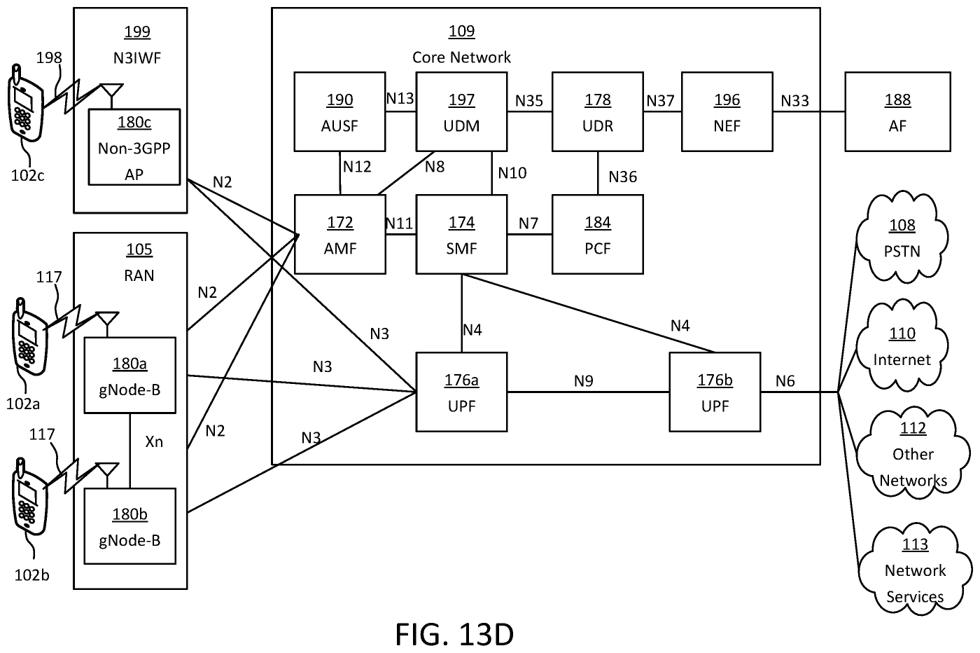

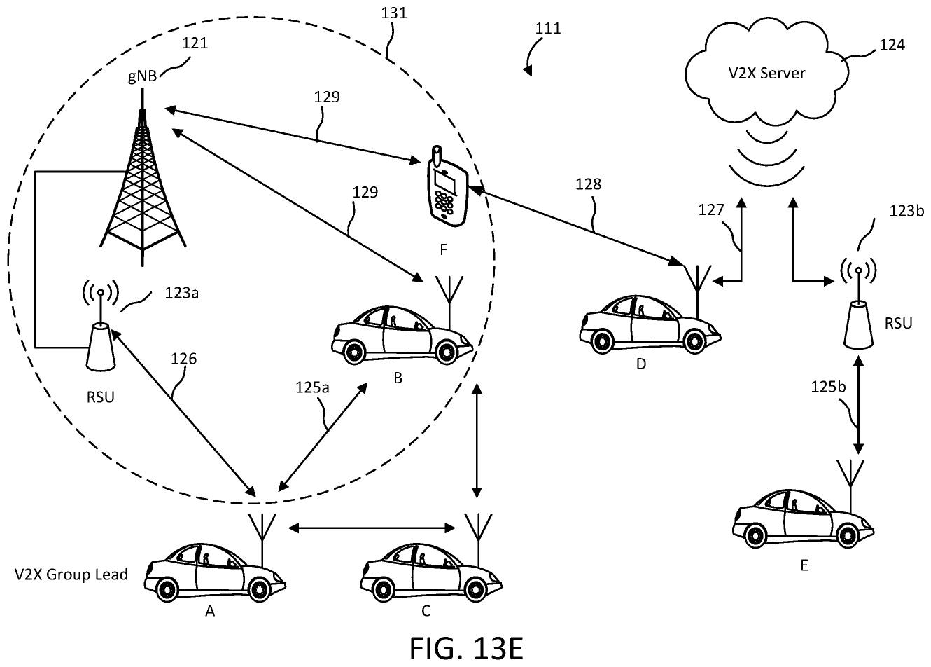

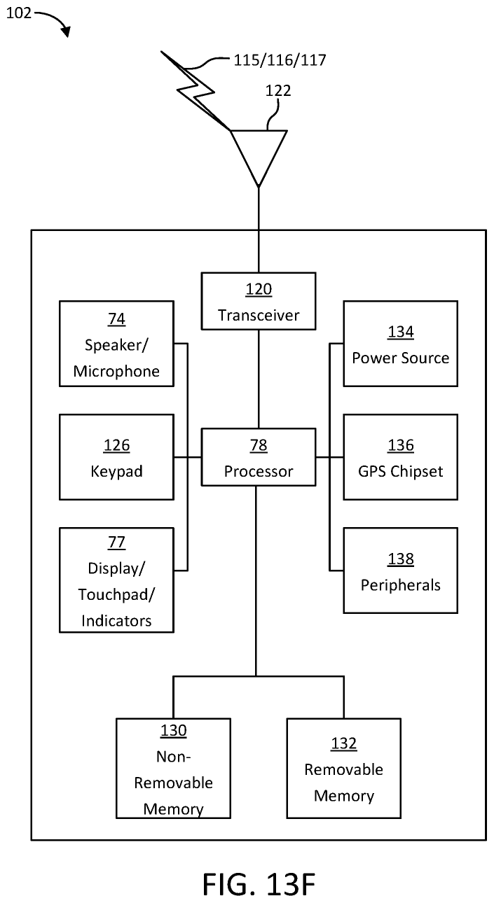

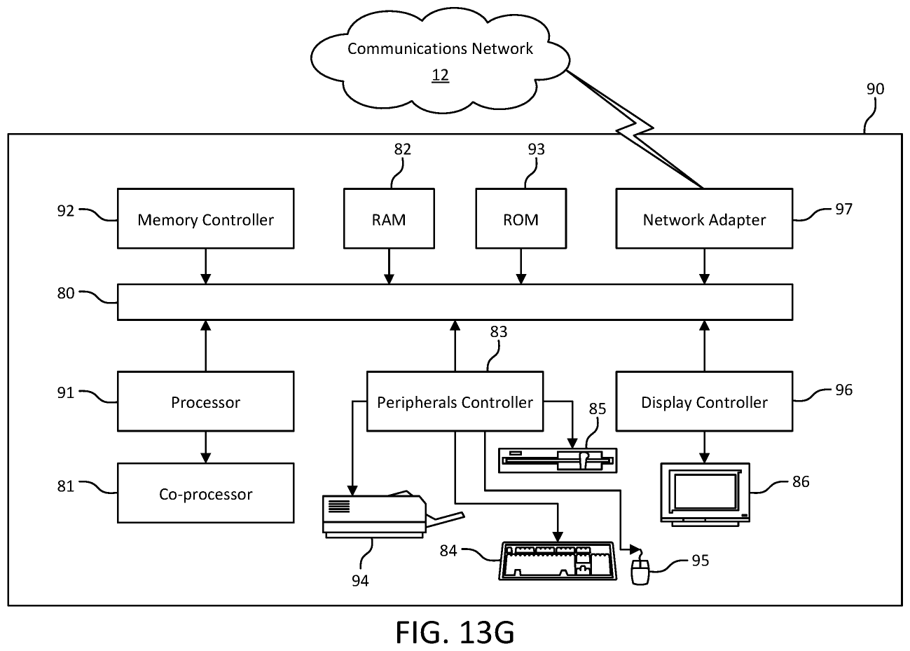

It is understood that the entities performing the steps illustrated herein may be logical entities. The steps may be stored in a memory of, and executing on a processor of, a device, server, or computer system such as those illustrated in FIG. 13F or FIG. 13G. Skipping steps, combining steps, or adding steps between exemplary methods disclosed herein is contemplated. Table 3 discloses abbreviations and definitions.

TABLE 3
Abbreviations and Definitions

| Abbreviations | Definitions |
|---|---|
| 3GPP | 3rd Generation Partnership Project |
| 5GC | 5G CN |
| AKA | Authentication and Key Agreement |
| AM | Acknowledged Mode |
| AMF | Access and Mobility Management Function |
| AN | Access Network |
| AS | Access Stratum |
| AUSF | Authentication Server Function |
| BAP | Backhaul Adaptation Protocol |
| BSR | Buffer Status Report |
| CC | Component Carrier |
| CE | Control Element |
| CN | Core Network |
| CP | Control Plane |
| DAPS | Dual Active Protocol Stack |
| DoS | Denial of Service |
| DCI | Downlink Control Information |
| DRB | Data Radio Bearer |
| EPS | Evolved Packet System |
| HFN | Hyper Frame Number |
| HN | Home Network |
| ID | Identity |
| IE | Information Element |
| LCH | Logical Channel |
| LCID | Logical Channel Identity |
| LSB | Least Significant Bits |
| MAC | Medium Access Control Protocol |
| MAC | Message Authentication Code |
| ME | Mobile Entity |
| MIB | Master Information Block |
| MIMO | Multiple Input Multiple Output |
| MSB | Most Significant Bits |
| NAS | Non-Access Stratum |
| NCC | Next Hop Chaining Counter |
| NEA | Encryption Algorithm for 5G |
| NH | Next Hop |
| NIA | Integrity Algorithm for 5G |
| PDCP | Packet Data Convergence Protocol |
| PDU | Protocol Data Unit |
| PHY | Physical Layer |
| RAT | Radio Access Technology |
| RLC | Radio Link Control |
| RNTI | Radio Network Temporary Identifier |
| RRC | Radio Resource Control |
| SAP | Service Access Point |
| SDAP | Service Data Adaptation Protocol |
| SEAF | Security Anchor Function |
| SI | System Information |
| SIB | System Information Block |
| SL | Side Link |
| SN | Serving Network |
| SRB | Signaling Radio Bearer |
| TB | Transport Block |
| TM | Transparent Mode |
| TRP | Transmission and Reception Point |
| TTI | Transmission Time Interval |
| UE | User Equipment |
| UM | Unacknowledged Mode |
| UP | User Plane |
| USIM | Universal Subscriber Identity Module |

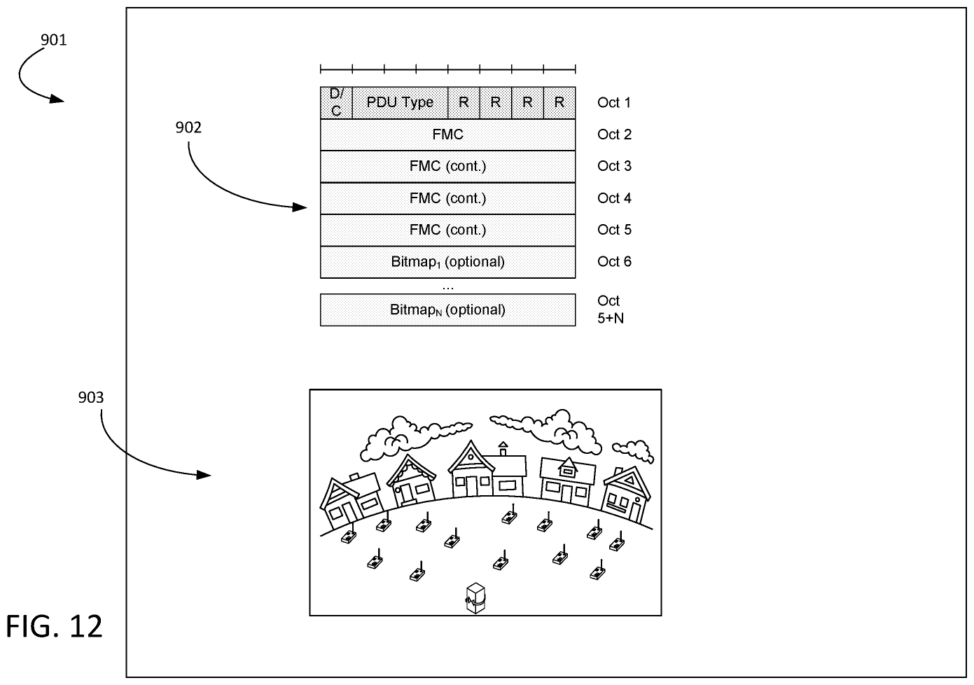

FIG. 12 illustrates an exemplary display (e.g., graphical user interface-GUI) that may be generated based on the methods, systems, and devices of NR security enhancements, as discussed herein. Display interface 901 (e.g., touch screen display) may provide text in block 902 associated with of NR security enhancements, such as related parameters, method flow, and associated current conditions. Progress of any of the steps (e.g., sent messages or success of steps) discussed herein may be displayed in block 902. In addition, graphical output 902 may be displayed on display interface 901. Graphical output 903 may be the topology of the devices implementing the methods, systems, and devices of NR security enhancements, a graphical output of the progress of any method or systems discussed herein, or the like.

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHZ, and the provision of new ultra-mobile broadband radio access above 7 GHZ. The flexible radio access is expected to consist of a new, non-backwards compatible radio access in new spectrum below 6 GHZ, and it is expected to include different operating modes that may be multiplexed together in the same spectrum to address a broad set of 3GPP NR use cases with diverging requirements. The ultra-mobile broadband is expected to include cmWave and mmWave spectrum that may provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), Non-Terrestrial Networks (NTN), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 13A illustrates an example communications system 100 in which the methods and apparatuses of NR security enhancements, such as the systems and methods illustrated in FIG. 1 through FIG. 9 described and claimed herein may be used. The communications system 100 may include wireless transmit/receive units (WTRUs) 102a, 102b, 102c. 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a. 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 13A, FIG. 13B, FIG. 13C, FIG. 13D, FIG. 13E, or FIG. 13F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 13A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of NR security enhancements, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a. 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 13A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of NR security enhancements, as disclosed herein. In an example, the base station 114c and the WTRUs 102, e.g., WTRU 102e, may implement a radio technology such as IEEE 802.11 to establish a wireless local area network (WLAN), similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 13A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VOIP) services to one or more of the WTRUs 102a, 102b, 102c, 102d. For example, the core network 106/107/109 may provide control, billing services, mobile location-based services, pre-paid calling, Internet connectivity, packet data network connectivity, Ethernet connectivity, video distribution, etc., or perform high-level security functions, such as user authentication.

Although not shown in FIG. 13A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c. 102d, 102e, and 102f may include multiple transceivers for communicating with different wireless networks over different wireless links for implementing methods, systems, and devices of NR security enhancements, as disclosed herein. For example, the WTRU 102g shown in FIG. 13A may be configured to communicate with the base station 114a, which may employ a cellular-based radio technology, and with the base station 114c, which may employ an IEEE 802 radio technology.

Although not shown in FIG. 13A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 13B is a system diagram of an example RAN 103 and core network 106 that may implement methods, systems, and devices of NR security enhancements, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 13B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 13B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 13B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a. 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 13C is a system diagram of an example RAN 104 and core network 107 that may implement methods, systems, and devices of NR security enhancements, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 13C, the eNode-Bs 160a, 160b, and 160c may communicate with one another over an X2 interface.

The core network 107 shown in FIG. 13C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a. 160b, and 160c in the RAN 104 via the SI interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 13D is a system diagram of an example RAN 105 and core network 109 that may implement methods, systems, and devices of NR security enhancements, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 13D, the gNode-Bs 180a and 180b may communicate with one another over an Xn interface, for example.

The core network 109 shown in FIG. 13D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 13G.

In the example of FIG. 13D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional elements, and may consist of multiple instances of each of these elements. FIG. 13D shows that network functions directly connect with one another, however, it should be appreciated that they may communicate via routing agents such as a diameter routing agent or message buses.

In the example of FIG. 13D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a. 102b, and 102c via an N1 interface. The N1 interface is not shown in FIG. 13D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a. 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 13D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more “virtual” core networks behind the operator's air interface. This involves ‘slicing’ the core network into one or more virtual networks to support different RANs or different service types running across a single RAN. Network slicing enables the operator to create networks customized to provide optimized approaches for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 13D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 13A, FIG. 13C, FIG. 13D, or FIG. 13E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 13A, FIG. 13B, FIG. 13C, FIG. 13D, or FIG. 13E are provided by way of example only, and it is understood that the subject matter disclosed and claimed herein may be embodied or implemented in any similar communication system, whether presently defined or defined in the future.

FIG. 13E illustrates an example communications system 111 in which the systems, methods, apparatuses that implement NR security enhancements, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUS A, B, C, D, E, and F may communicate with each other over a Uu interface 129 via the gNB 121 if they are within the access network coverage 131. In the example of FIG. 13E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 13E. WRTU D, which is outside of the access network coverage 131, communicates with WTRU F, which is inside the coverage 131.

WTRUS A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 13F is a block diagram of an example apparatus or device WTRU 102 (e.g., UE 102) that may be configured for wireless communications and operations in accordance with the systems, methods, and apparatuses that implement NR security enhancements, described herein, such as a WTRU 102 of FIG. 13A, FIG. 13B, FIG. 13C, FIG. 13D, or FIG. 13E, or FIG. 1-FIG. 9. As shown in FIG. 13F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 13F and may be an exemplary implementation that performs the disclosed systems and methods for NR security enhancements described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 13F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 13A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, Radar, L1DAR, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 13F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup of the NR security enhancements in some of the examples described herein are successful or unsuccessful, or otherwise indicate a status of NR security enhancements and associated components. The control lighting patterns, images, or colors on the display or indicators 77 may be reflective of the status of any of the method flows or components in the FIG.'s illustrated or discussed herein (e.g., FIG. 7-FIG. 9, etc.). Disclosed herein are messages and procedures of NR security enhancements. The messages and procedures may be extended to provide interface/API for users to request resources via an input source (e.g., speaker/microphone 74, keypad 126, or display/touchpad/indicators 77) and request, configure, or query NR security enhancements related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth R module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 13G is a block diagram of an exemplary computing system 90 in which one or more apparatuses of the communications networks illustrated in FIG. 4, FIG. 3, FIG. 1, FIG. 13A, FIG. 13C, FIG. 13D and FIG. 13E as well as NR security enhancements, such as the systems and methods illustrated in FIG. 7 through FIG. 11 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for NR security enhancements, such as receiving security related messages.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space: it cannot access memory within another process's virtual address space unless memory sharing between the processes has been set up.

In addition, computing system 90 may include peripherals controller 83 responsible for communicating instructions from processor 91 to peripherals, such as printer 94, key board 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90) may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 13A, FIG. 13B, FIG. 13C, FIG. 13D, or FIG. 13E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—NR security enhancements—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, or apparatuses, among other things, as described herein may provide for determining a radio protocol data type of a plurality of radio protocol data types of information transmitted in a communication: based on the radio protocol data type, selecting, for performing a security function on the information, one or more input parameters specific to the radio protocol data type; and performing the security function on the information using the one or more input parameters specific to the radio protocol data type. The security function comprises a ciphering protection function or an integrity protection function. The plurality of radio protocol data types comprises control protocol data unit (PDU), header of radio protocol control PDU, or common RRC messages. Methods, systems, or apparatuses, among other things, as described herein may provide for determining a radio protocol data type of a plurality of radio protocol data types of information transmitted in a communication, wherein the plurality of radio protocol data types comprise control protocol data unit (PDU), header of control PDU, header of data PDU, or radio resource control (RRC) message using common control channel (CCCH). All combinations in this paragraph and the below paragraphs (including the removal or addition of steps) are contemplated in a manner that is consistent with the other portions of the detailed description.

Methods, systems, or apparatuses, among other things, as described herein may provide for receiving information about capabilities or supported features of the controlled entity: based on the information, configuring a feature, wherein the configuration is associated with a bit combination to be used for subsequent deactivation or re-activation of the configured feature; and upon deactivation of the feature, sending a bit combination as control information to the controlled entity to indicate deactivation. Upon re-activation, the controlling entity sending the same bit combination to indicate re-activation of the deactivated feature. The re-activation conveys explicit indication of the feature status. The bit combination is accompanied with an explicit indication of the feature status. All combinations in this paragraph (including the removal or addition of steps) are contemplated in a manner that is consistent with the other portions of the detailed description.

Methods, systems, or apparatuses, among other things, as described herein may provide for determining a first radio protocol data type of a plurality of radio protocol data types of first data used in a communication: selecting, based on the first radio protocol data type, one or more first input parameters specific to the first radio protocol data type for performing a first security function on the first data: performing the first security function on the first data using the one or more input parameters specific to the first radio protocol data type: determining a second radio protocol data type of the plurality of radio protocol data types of data used in the communication, wherein the first radio protocol data type and the second radio protocol data type are different: selecting, based on the second radio protocol data type, one or more second input parameters specific to the second radio protocol data type for performing a second security function on the data; and performing the second security function on the second data using the one or more input parameters specific to the second radio protocol data type.

Methods, systems, or apparatuses, among other things, as described herein may provide for performing security protection functions. Methods, systems, or apparatuses, among other things, as described herein may provide for receiving a bearer identifier (ID) parameter; and determining, based on the bearer ID parameter, an input parameter for performing a security function associated with control data units generated by a protocol entity. RRC provides Bearer ID parameter upon configuration of the protocol entity and the Bearer ID of the protocol entity is used as an input parameter for the security protection of control data units generated by the protocol entity. The bearer ID parameter is from a radio resource control protocol. The enhanced security protection function comprises of security protection of a one or more of radio protocol data types, where the data type is one or more of control protocol data unit (PDU), header of radio protocol control PDU, common RRC messages, the device determines one or more input specific to the data type for the performing of the enhanced security function, performs the enhanced security protection function using the determined input.

What is claimed is:

1.-20. (canceled)

21. A device comprising:
a processor; and
a memory coupled with the processor, the memory storing executable instructions that when executed by the processor cause the processor to effectuate operations comprising:
receiving information associated with a communication;
determining a radio protocol data type of a plurality of radio protocol data types associated with the information transmitted in the communication, wherein the plurality of radio protocol data types comprise control protocol data unit (PDU), header of control PDU, header of data PDU, or radio resource control (RRC) message using common control channel (CCCH);
based on the radio protocol data type, selecting, for performing a security function on the information, one or more input parameters specific to the radio protocol data type; and
performing the security function on the information using the one or more input parameters specific to the radio protocol data type.

22. The device of claim 21, wherein the security function comprises a ciphering protection function.

23. The device of claim 21, wherein the security function comprises an integrity protection function.

24. The device of claim 21, wherein the one or more input parameters comprises a bearer parameter.

25. The device of claim 21, wherein the one or more input parameters comprises a count parameter.

26. The device of claim 21, wherein the one or more input parameters comprises a message parameter.

27. The device of claim 21, wherein the one or more input parameters comprises bearer identifier associated with a packet data convergence protocol (PDCP).

28. The device of claim 21, wherein the device comprises a wireless transmit/receive unit.

29. The device of claim 21, wherein the one or more input parameters comprises a count parameter composed of a concatenation of a sequence number of packet data convergence protocol (PDCP).

30. A method comprising:
receiving information associated with a communication;
determining a radio protocol data type of a plurality of radio protocol data types associated with the information transmitted in the communication, wherein the plurality of radio protocol data types comprise control protocol data unit (PDU), header of control PDU, header of data PDU, or radio resource control (RRC) message using common control channel (CCCH);
based on the radio protocol data type, selecting, for performing a security function on the information, one or more input parameters specific to the radio protocol data type; and
performing the security function on the information using the one or more input parameters specific to the radio protocol data type.

31. The method of claim 30, wherein the security function comprises a ciphering protection function.

32. The method of claim 30, wherein the security function comprises an integrity protection function.

33. The method of claim 30, wherein the one or more input parameters comprises a bearer parameter.

34. The method of claim 30, wherein the one or more input parameters comprises a count parameter.

35. The method of claim 30, wherein the one or more input parameters comprises a message parameter.

36. The method of claim 30, wherein the one or more input parameters comprises bearer identifier associated with a packet data convergence protocol (PDCP).

37. The method of claim 30, wherein the control PDU comprises a backhaul adaptation protocol (BAP) Control PDU.

38. The method of claim 30, wherein the one or more input parameters comprises a bearer identifier (ID) and logical channel ID.

39. The method of claim 30, wherein the one or more input parameters comprises a logical channel identifier (ID) and cell ID.

40. The method of claim 30, wherein the one or more input parameters comprises a cell group identifier (ID).
